(19) United States
(12) Patent Application Publication
(10) Pub. No.: US 2003/0225665 A1
(43) Pub. Date: Dec. 4, 2003

(54) Methods for financing properties using structured transactions

(76) Inventors: Richard A. Gross, Washington, DC (US); Hugh P. Quinn, Falls Church, VA (US)

Correspondence Address: NIXON & VANDERHYE, PC, 1100 N GLEBE ROAD, 8TH FLOOR, ARLINGTON, VA, 22201-4714, US

(21) Appl. No.: 10/417,338

(22) Filed: Apr. 17, 2003

Related U.S. Application Data
(60) Provisional application No. 60/373,326, filed on Apr. 18, 2002.

(51) Int. Cl. G06F 17/60

(52) U.S. Cl. 705/36

(57) ABSTRACT

A method of financing real estate in which the ownership of a building and its underlying land is separated and leased in a manner that provides advantageous results for all parties to the transaction. a novel method of using an accrual to achieve advantageous accounting treatment for the parties to the transaction. The transaction is structured to enable the lessee to achieve operating lease treatment, thereby avoided an adverse impact on the lessee's balance sheet. The transaction is also structured to achieve leverage lease accounting treatment for the lessor.

### RELATED APPLICATIONS

This application claims the benefit of U.S. Provisional Application Serial No. 60/373,326 entitled “Method and System for Funding Properties,” filed Apr. 18, 2002, the entire content of which is incorporated by reference herein.

### FIELD OF THE INVENTION

The instant invention relates to a new and improved method for financing properties, and, more particularly, to an improved property financing method that enables property owners and investors to achieve advantageous results through the financing of new construction, renovation of existing structures and transfer of existing structures, regardless of whether the parties to the transaction are tax-paying entities or tax-indifferent parties. The invention provides a novel method of using an accrual to achieve advantageous accounting treatment for the parties to the transaction. The transaction is structured to enable the lessee to achieve operating lease treatment, thereby avoiding an adverse impact on the lessee's balance sheet and enhancing its credit ratings. The transaction is also structured to achieve leverage lease accounting treatment for the lessor, thereby providing favorable operating results on its reported financial statements, positive cash flow throughout the life of the investment, and significant tax benefits.

### BACKGROUND AND SUMMARY OF THE INVENTION

One of the instant inventors, Richard Gross, developed and used a unique real estate financing model in transactions he structured for his clients. The model was developed for tax-indifferent parties who wanted to construct or rehabilitate buildings on land they owned but lacked the necessary funding to do so. Mr. Gross proposed that each of these parties lease its land to private investors which would, in turn, either construct a new building, or rehabilitate an existing building, on the leased ground. The investors would lease the ground pursuant to a long-term ground lease under which payment of the ground rent could be deferred and accrued, together with compounding interest, during the initial twenty years of the ground lease term. The tax-indifferent party would record the deferred rent and accrued interest as income during this period. The investors, as accrual-based taxpayers, would record and deduct the ground rent and the associated interest as a current expense even though the actual payment would not occur at that time. The tax-indifferent party would then lease the newly constructed or rehabilitated building from the investors. After twenty years the investors would either pay any deferred ground rent plus accrued interest thereon in cash or relinquish the property in which case the ground lease would terminate, leaving the tax-indifferent party owning both the ground and building.

The consummated transactions generally involved the rehabilitation of buildings for which an historic rehabilitation tax credit was available under the Internal Revenue Code. The investors, having assumed all benefits and burdens of ownership of the building throughout its useful life pursuant to the ground lease, would be treated as the owner of the building for Federal income tax purposes and would be entitled to this credit as well as annual tax deductions for (a) depreciation, (b) interest payments, and (c) the accrued ground rent and interest on the accruals. The transactions typically provided the investors with both a cash and tax return but required them to recognize substantial losses on their financial statements prepared in accordance with generally accepted accounting principles (“GAAP”) as a result of these deductible costs. Because of these losses, the transactions were of limited use to most investors. Even though investors could receive an overall return of between 18% to 25% on their investments as a result of the historic rehabilitation tax credit, the impact on the investors' public financial statements severely curtailed the usefulness and attractiveness of the transactions.

Consequently, the original model had several significant drawbacks. First, the transaction was limited to the construction of new buildings or the renovation of existing buildings. It was never applied to existing structures that were not in need of renovation. Second, because of the grave impact to the investor' financial statements, the majority of investors were not interested in the transaction unless they could receive a rehabilitation tax credit sufficient to achieve returns which would offset this harmful impact on their income statements. Third, property owners were reluctant to use the structure if they had to reflect the real property and its associated liabilities on their balance sheets under GAAP as this negatively affected their credit ratings. Fourth, the transaction was applicable only to structures currently owned by or to be constructed for a tax-indifferent party. Combined, these four impediments severely limited the usefulness and applicability of the original transaction model.

Thus, a need existed for a new and improved real estate financing model that overcame the disadvantages of the prior model. The present invention was developed to meet this need.

The instant inventors have added substantial innovations to the prior model which have eliminated its major drawbacks and facilitated a broader application by property owners and investors. The innovations enable the model to be used for the financing of existing buildings not in need of renovation, thereby affording initial cash payments to property owners. In accordance with an important aspect of the invention, leverage lease treatment has been made available for investors thus avoiding GAAP losses on their income statements. In addition, operating lease treatment has been made available for property owners thus removing the real estate and its associated liabilities from their balance sheets and enhancing their credit ratings. The model has also been made applicable to properties having low land values. Finally, the model was adapted for both tax-paying property owners as well as tax-indifferent ones.

The first innovation involves applying the model to the sale of existing structures that do not need renovation. Cash that would have been required to renovate a building, or construct a new building, is therefore available to be paid to the original property owner. While a sale-leaseback is not a new concept, the model uses accruing ground rent in a novel manner to achieve advantageous results for the parties to the sale-leaseback transaction.

Next, and perhaps most importantly, the model has been redesigned to eliminate the negative financial statement impact to the investors under GAAP while still providing them positive cash flow, attractive returns and significant tax benefits. The elimination of the transaction's negative impact on the investors' financial statements is achieved through the application of leverage lease accounting under the accounting rule set forth in Financial Accounting Standards Board Rule 13 (“FASB 13”). Generally, FASB 13 requires identical classification of a lease as either a capital lease or an operating lease in the financial statements of both parties to the lease. Property owners will often not participate in a sale leaseback without the resulting leaseback accounted for as an operating lease in their financial statements. On the other hand, if the building leaseback is treated as an operating lease by the investors who acquire the building, they will be required to show losses on their financial statements due to the deductions they are taking as discussed above. If the lease were classified as a capital lease on the investors' financial statements, then they could apply leverage lease accounting to eliminate the negative impact of these deductions on their financial statements.

FASB 13 sets forth four criteria to a lease transaction to determine whether the lease should be classified as an operating lease or as a capital lease; the same four criteria must be applied by both the lessee and the lessor to the lease. Under the first three criteria, the lease is a capital lease to both parties if (a) the lease transfers ownership of the property to the lessee by the end of the lease, (b) the lease contains a bargain purchase option, or (c) the lease term is equal to 75% or more of the estimated economic life of the property. Under the fourth criterion, if the present value at the beginning of the lease term of the minimum lease payments to be paid by the lessee exceeds 90% of the fair market value (“FMV”) of the property at the inception of the lease, then the lease is a capital lease. It is only the fourth criterion that provides some flexibility such that the lease may properly be considered as an operating lease by the lessee and a capital lease by the lessor.

The inventors have creatively crafted a unique approach to this problem. In accordance with one embodiment of the invention (the “PFG model”), the original owner of the land and building is the lessor of the land but the lessee of the building pursuant to its leaseback. By “netting” the payment stream of the land rent against that of the building rent, the minimum lease payments for the original land owner/building lessee are decreased. An example best illustrates this scenario. Assume the original tax-indifferent owner of real estate valued in total at $10 million sold the building to investors while leasing the underlying land to the same investors at an annual rate of $100,000, though deferred for 20 years. Further assume that investors leased the building back to the tax-indifferent party at an annual rate of $1 million. Since the $1 million lease rate payable by the tax-indifferent party to the investors constitutes rent for the building and a sublease of the land, and the underlying land is being leased to the investors for $100,000, the minimum lease payment by the tax indifferent party is $900,000 for purposes of the FASB 13 determination. This payment stream would be compared with the FMV of the real property, both land and building, to determine whether the 90% test were met, using the tax indifferent party's relatively low cost of funds.

This netting effect has a significant effect on lease classification under FASB 13. If the present value of the entire $1,000,000 rent payment stream was considered and exceeded 90% of the FMV of the real property, then the lessee would have to capitalize the asset. Thus, the tax-indifferent party would be required to reflect on its balance sheet ownership of the real property with a value of $10 million. However, under the PFG model, the “net” of the ground rent and the building rent is used in determining the FASB 13 calculation. After netting, the present value does not exceed 90% of the FMV of the property and, as a result, the tax-indifferent party is able to obtain operating lease classification.

In accordance with another embodiment of the invention (the “CPFG model”), the lessee is a tax-paying entity in contrast to the lessee in a PFG transaction. Consequently, the lessee's cost of funds is generally higher. Thus, when applying the fourth prong of FASB 13 to the transaction, a higher implicit interest rate is utilized. As a result, the lessee in a CPFG transaction still passes the fourth prong and can treat the lease as an operating lease.

The investors in the above examples would have a minimum lease payment of $1,000,000, the rent received for the leaseback of the building together with sub-leasing of the land (leaseback of the land in a CPFG transaction). Since the investors acquired only the building, the $1,000,000 together with residual value inuring to the benefit of investors is measured against the value of the building only to determine their implicit rate in the transaction. This results in a present value rent calculation exceeding the 90% test of FASB 13, thereby resulting in capital lease classification in both models. Alternative embodiments are provided in which either a bargain purchase option is utilized or a variable interest entity (“VIE”) is established to achieve the desired accounting treatment for the lessor (i.e., capital lease treatment on the land). Once the transaction is considered a capital lease, the investors are able to utilize leverage lease treatment. The result of the leverage lease treatment is that, under GAAP, the investors no longer need to declare losses on their financial statements as a result of the transaction because the gain recognized by the investors in the twentieth year would be allocated over the initial years of the lease term, thereby offsetting the effects of the deductions taken during this period. The investors then have both positive income on their financial statements and positive cash flow throughout the term of the building leaseback, as well as significant tax benefits from the transaction. As a result of the impact directly attributable to leverage lease treatment, the transactions no longer require as high a return as that provided from transactions utilizing tax credits under the original model. Thus, the PFG/CPFG transactions are no longer dependent on the historic rehabilitation tax credit and many more investors can advantageously take part in them.

The instant inventors have recognized that some properties do not have sufficient land value to support the necessary accrual to provide the benefits described above. However, in accordance with the instant invention, in these instances and in instances where additional cash may be needed for construction/renovation, the deferral feature of the model has been expanded to incorporate deferrals of amounts due with respect to other tangible and/or intangible assets. For example, the land owner may lend money to the investors and such debt may be repaid on a deferral basis in the same manner, and with the same consequences, as deferred ground rent. Thus, the instant invention can be used even when the target property does not have sufficient land value for accrual purposes by deferring amounts due with respect to other tangible and/or intangible assets.

Another major innovation in the model has made it more attractive to property owners. As noted above, all of the prior applications required that the original owner of the real property be a tax-indifferent party. However, the CPFG model modifies the PFG model so that taxpaying entities such as corporations can sell their real property and lease it back at below market rental rates. First, in accordance with the CPFG model, the corporation sells the land underlying its building to a tax-indifferent party. The tax-indifferent party then leases the land to investors pursuant to, for example, a 65 year ground lease with the first 20 years rent deferred with compounding interest at the investors' option. The corporation then sells its building to the investors and leases both the land and building back from the investors for a twenty year term. At the end of the lease term to the corporation, the investors must pay the accrual due to the tax-indifferent party or relinquish the property to the tax-indifferent party. If the accrued obligation is fully paid in cash, the tax-indifferent party still obtains ownership of the building and return of the land upon the expiration of the ground lease, or sooner if the investors default thereunder. Thus, the CPFG model of the instant invention enables the tax-indifferent party to acquire both the land and the building for the price of the land alone. The transaction provides a significant return to the tax-indifferent party similar to the effect of a zero-coupon bond. At the same time, the investors are able to receive a significant return on their investment, favorable treatment on their balance sheet due to leverage lease treatment, positive cash flow throughout the life of the lease, and significant tax benefits. This allows the investors to provide a favorable leaseback rate to the corporation and a high return to the tax-indifferent party. Moreover, the structure is now available for many more properties than simply those with historic buildings in need of renovation.

As indicated above, a suitable ground lease is used in transactions under the models described herein. The specific terms of the ground lease can vary as long as the objectives discussed herein are met. A sample ground lease that is preferably used when implementing the instant invention is included as Attachment 1 to the above-referenced provisional application. While the sample ground lease includes a 65 year lease with a 20 year initial deferral period, these time periods may vary depending on the particular implementation of the instant invention. As a general guideline, however, the length of the ground lease should be sufficient to qualify as a true sale under the applicable tax code (generally assumed to be over 50 years). Thus, in the preferred embodiment of the invention, the ground lease is for at least 50 years and possibly as long as 65 years or more. The length of the deferral period can also vary. However, it has been found that most implementations of the invention will use between 15 and 25 years (preferably 20 years) for this initial deferred payment period. The deferral period is preferably less than 75% of the estimated economic life of the building being leased. Thus, the invention is not limited to use with the specific terms of the sample ground lease.

### BRIEF DESCRIPTION OF THE DRAWINGS

These and other features, objects and advantages of the instant invention will become apparent from the following detailed description of the invention, when read in conjunction with the appended drawings, in which:

FIG. 1 is a flow chart illustrating the main stages of a PFG structured transaction for financing properties, in accordance with a first embodiment of the instant invention involving the sale of an existing building;

FIG. 2 is a flow chart illustrating the main stages of a PFG structured transaction for financing properties, in accordance with a second embodiment of the instant invention involving the construction or renovation of a building;

FIG. 3 is a flow chart illustrating a first exit strategy for a PFG structured transaction in which the special purpose entity (“SPE”) established by the equity investors to own the building surrender the building, in accordance with an exemplary embodiment of the instant invention;

FIG. 4 is a flow chart illustrating a second exit strategy for a PFG transaction in which the accrual is paid off, in accordance with an exemplary embodiment of the instant invention;

FIG. 5 is a structure diagram illustrating a first part of a PFG structured transaction involving the sale of an existing building, in accordance with the first embodiment of the invention shown in FIG. 1;

FIG. 5A is a structure diagram illustrating an alternative first part of a PFG structured transaction involving the sale of an existing building, wherein a VIE is used as the land holder, in accordance with an embodiment of the invention shown in FIG. 1;

FIG. 5B is a structure diagram illustrating an alternative first part of a PFG structured transaction involving the sale of an existing building, wherein a bargain purchase option is available under the ground lease, in accordance with an embodiment of the invention shown in FIG. 1;

FIG. 6 is a structure diagram illustrating a second part of a PFG structured transaction involving the sale of an existing building, in accordance with the first embodiment of the invention shown in FIG. 1;

FIG. 7 is a structure diagram of a third part of a PFG structured transaction involving the sale of an existing building, in accordance with the first embodiment of the invention shown in FIG. 1;

FIG. 8 is a structure diagram of a first part of a PFG structured transaction involving the renovation or construction of a building, in accordance with the second embodiment of the invention shown in FIG. 2;

FIG. 9 is a structure diagram of a second part of a PFG structured transaction involving the renovation or construction of a building, in accordance with the second embodiment of the invention shown in FIG. 2;

FIG. 10 is a structure diagram of a third part of a PFG structured transaction involving the construction of a building, in accordance with the second embodiment of the invention shown in FIG. 2;

FIG. 11 is a structure diagram of a third part of a PFG structured transaction involving the renovation of a building, in accordance with the second embodiment of the invention shown in FIG. 2;

FIGS. 12a-12d illustrate the four stages of a PFG structured transaction, in accordance with an exemplary embodiment of the instant invention;

FIG. 13 is a flow chart illustrating the main stages of a CPFG structured transaction for financing properties, in accordance with a third embodiment of the instant invention;

FIG. 14 is a flow chart illustrating a first exit strategy for a CPFG structured transaction in which the accrual is paid off, in accordance with an exemplary embodiment of the instant invention;

FIG. 15 is a flow chart illustrating a second exit strategy for a CPFG transaction in which the SPE surrenders the building, in accordance with an exemplary embodiment of the instant invention;

FIG. 16 is a structure diagram illustrating a first part of a CPFG structured transaction, in accordance with the third embodiment of the invention shown in FIG. 13;

FIG. 16A is a structure diagram illustrating an alternative first part of a CPFG structured transaction wherein a VIE is used as the land holder, in accordance with the third embodiment of the invention shown in FIG. 13;

FIG. 16B is a structure diagram illustrating an alternative first part of a CPFG structured transaction wherein a bargain purchase option is available under the ground lease, in accordance with the third embodiment of the invention shown in FIG. 13;

FIG. 17 is a structure diagram illustrating a second part of a CPFG structured transaction, in accordance with the third embodiment of the invention shown in FIG. 13;

FIG. 18 is a structure diagram of a third part of a CPFG structured transaction, in accordance with the third embodiment of the invention shown in FIG. 13;

FIG. 19 shows the economics upon closing of a CPFG structured transaction, in accordance with an exemplary embodiment of the instant invention; and

FIGS. 20a-20d illustrate the four stages of a CPFG structured transaction, in accordance with an exemplary embodiment of the instant invention.

### DETAILED DESCRIPTION OF THE PREFERRED EMBODIMENTS

As indicated above, the instant invention provides improved real estate funding models that have beneficial results for the parties to the transaction. The first model is referred to as the PFG model and the second model is referred to as the CPFG model. These two models will be described in detail below.

There are often various issues facing tax-exempt entities. These issues may include a need for cash to fund projects, for example. However, a tax-exempt entity may be unwilling or unable to utilize bonding capacity to raise cash. In addition, the tax-exempt entity may have strained debt capacity. The PFG model of the instant invention addresses these and other issues by providing an innovative sale/leaseback structure that converts a tax-exempt entity's real estate into cash. The PFG model not only provides cash for the tax-exempt entity, but it also allows the tax-exempt entity to retain control and retake ultimate ownership of the property.

The PFG model provides more up-front cash to the tax-exempt entity than can be achieved using traditional debt financing through the sale of an existing building. The PFG model also enables construction or rehabilitation of a tax-exempt entity's building without encumbering assets or invading capital. In addition, the PFG model gives the tax-exempt entity operating leaseback having long-term fixed rates with renewals at discounted rates. The PFG model has attractive exit strategies allowing for reclamation by the tax-exempt entity of the entire property without additional payment. The PFG model also gives the tax-exempt entity control of the building use during the lease.

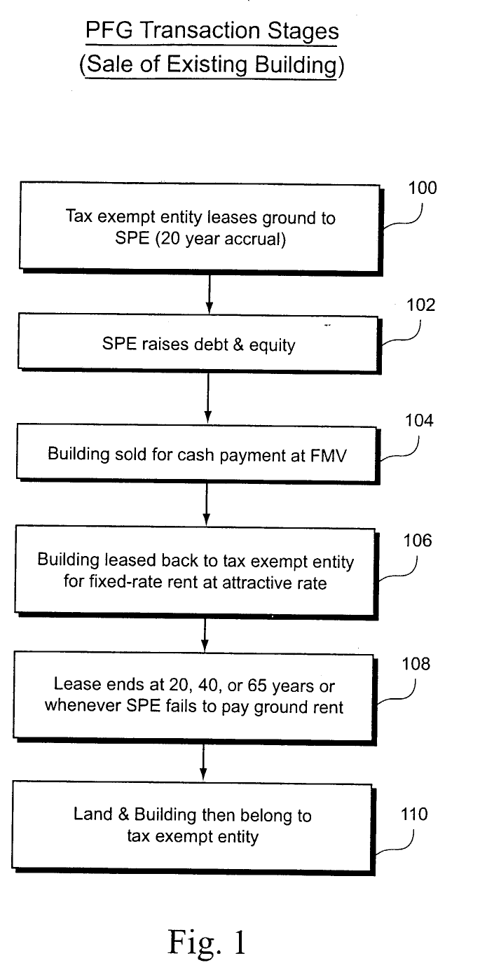

FIG. 1 is a high-level flow chart illustrating the main stages of a PFG structured transaction for financing properties, in accordance with a first embodiment of the instant invention involving the sale of an existing building owned by a tax-exempt (or tax-indifferent) entity. In the first step of this embodiment (step 100), the tax-exempt entity leases its ground to the SPE. In the next step (step 102), the SPE raises debt and equity for use in purchasing the building. The tax-exempt entity then sells the building to the SPE for a cash payment at FMV (step 104). The building is then leased back to the tax-exempt entity for fixed-rate rent at an attractive rate (step 106). The ground rent is then accrued, as in this example, for 20 years with interest. The lease ends at, for example, 20, 40 or 65 years or whenever the SPE fails to pay ground rent (step 108). The land and the building then belong to the tax-exempt entity (step 110).

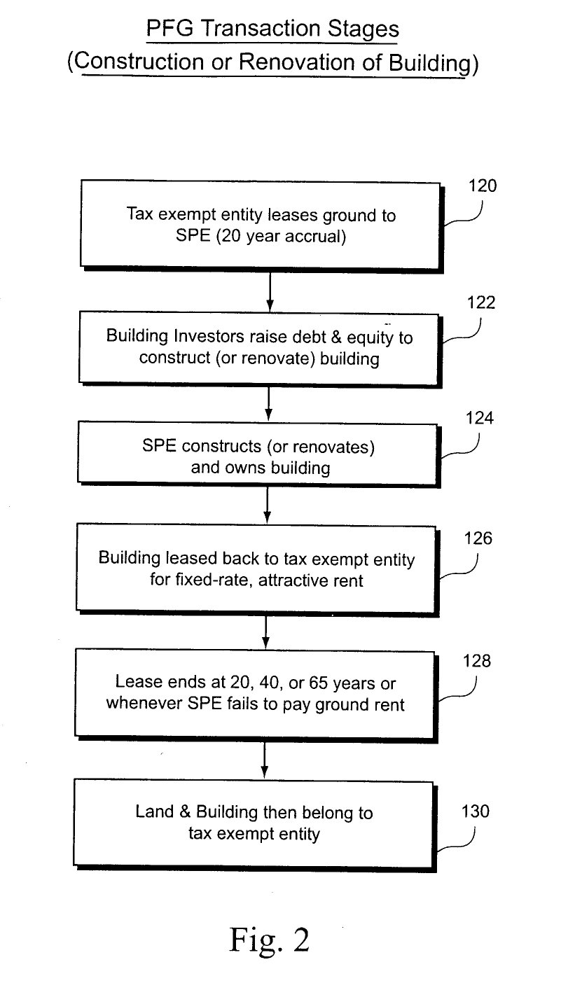

FIG. 2 is a high-level flow chart illustrating the main stages of a PFG structured transaction for financing properties, in accordance with a second embodiment of the instant invention involving the construction or renovation of a building owned by a tax-exempt entity. In the first step of this embodiment (step 120), the tax-exempt entity leases its ground to the SPE. In the next step (step 122), the SPE raises debt and equity to construct or renovate the building. The SPE then constructs (or renovates) and takes ownership of the building (step 124). The building is then leased back to the tax-exempt entity at an attractive rent (step 126). The ground rent accrues for, for example, 20 years with interest. The lease then ends at, for example, 20, 40 or 65 years or whenever the SPE fails to pay ground rent (128). The land and the building then belong to the tax-exempt entity (step 130).

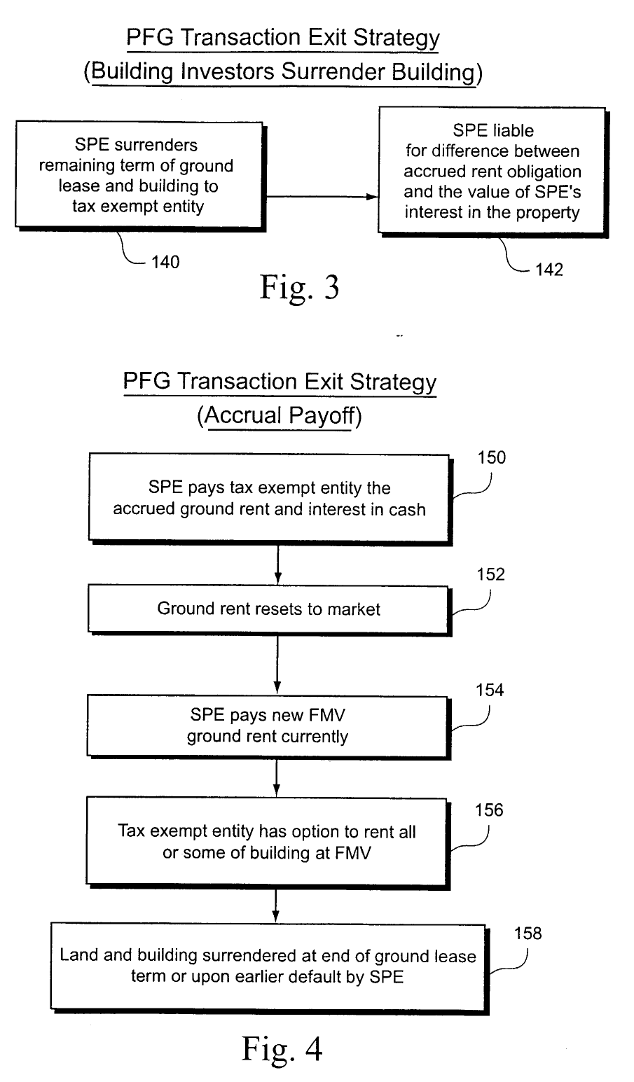

There are two preferred exit strategies for the PFG transaction. The first exit strategy involves a surrender of the building by the SPE and is illustrated in FIG. 3. As shown in FIG. 3, in this exit strategy, the SPE surrenders the remaining term of the ground lease and the building to the tax-exempt entity (step 140). The SPE is then liable for the difference between the accrued rent obligation and the value of the SPE's interest in the property (step 142). This liability may or may not be assumed by the SPE's equity investors.

A second exit strategy is illustrated in FIG. 4. As shown in FIG. 4, in this second exit strategy, the SPE pays the tax-exempt entity the accrued ground rent and interest in cash (step 150). The ground rent then resets to market (step 152). The SPE then pays new FMV ground rent currently (step 154). The tax-exempt entity then has the option to rent all or some of the building at FMV (step 156). The building is then surrendered at the end of the ground lease term (or upon any earlier default by the SPE) (step 158).

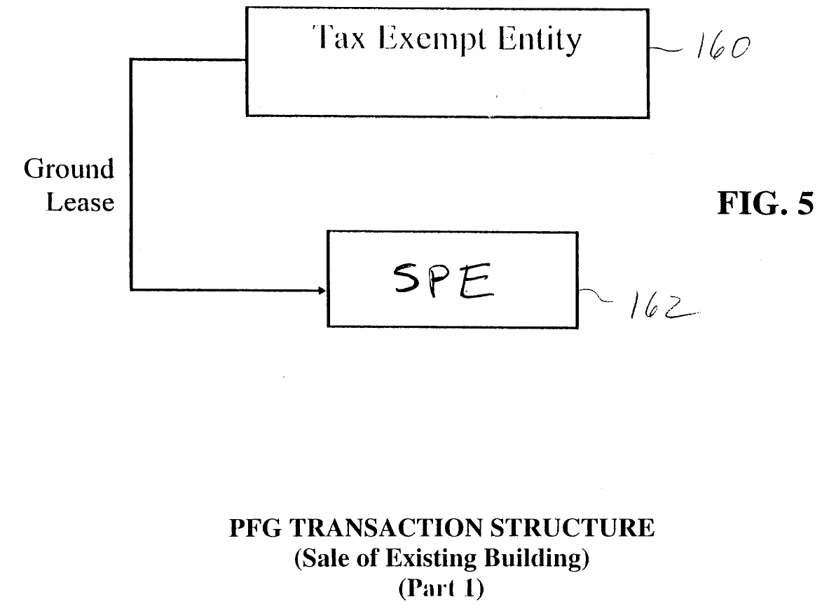

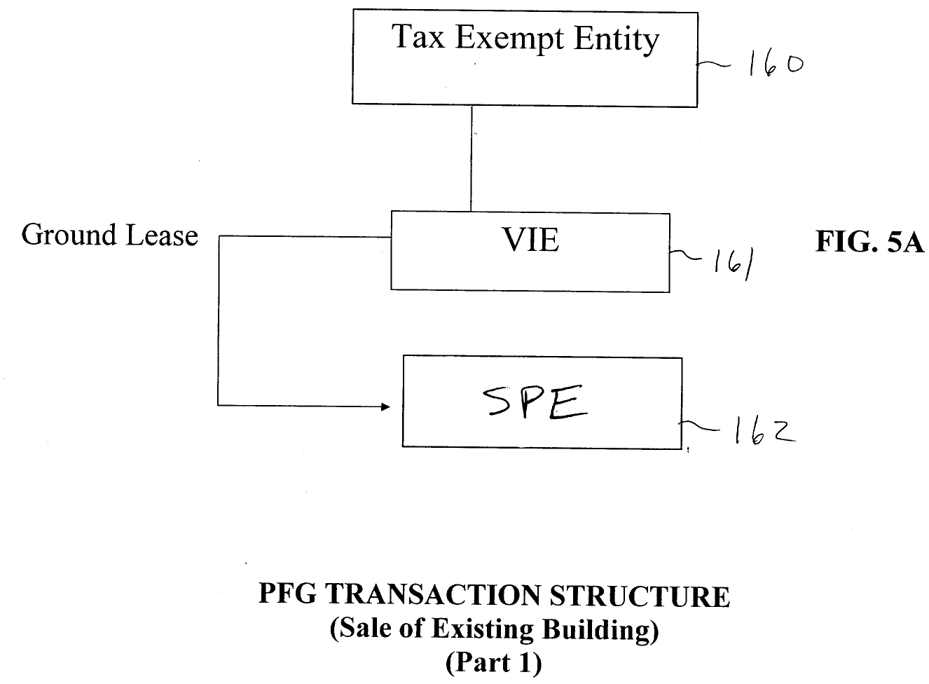

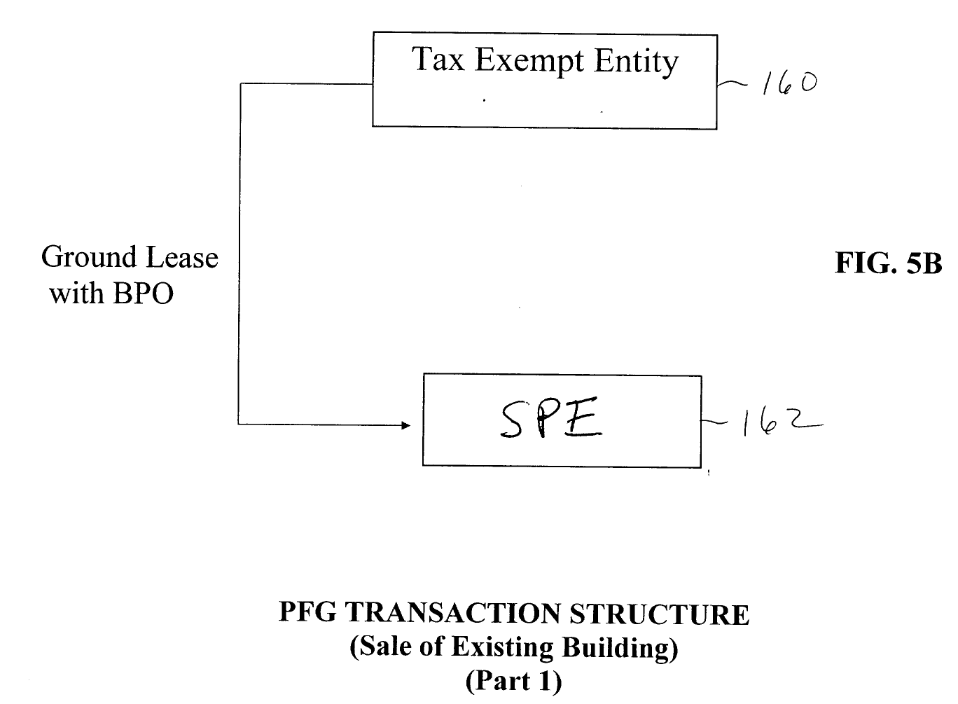

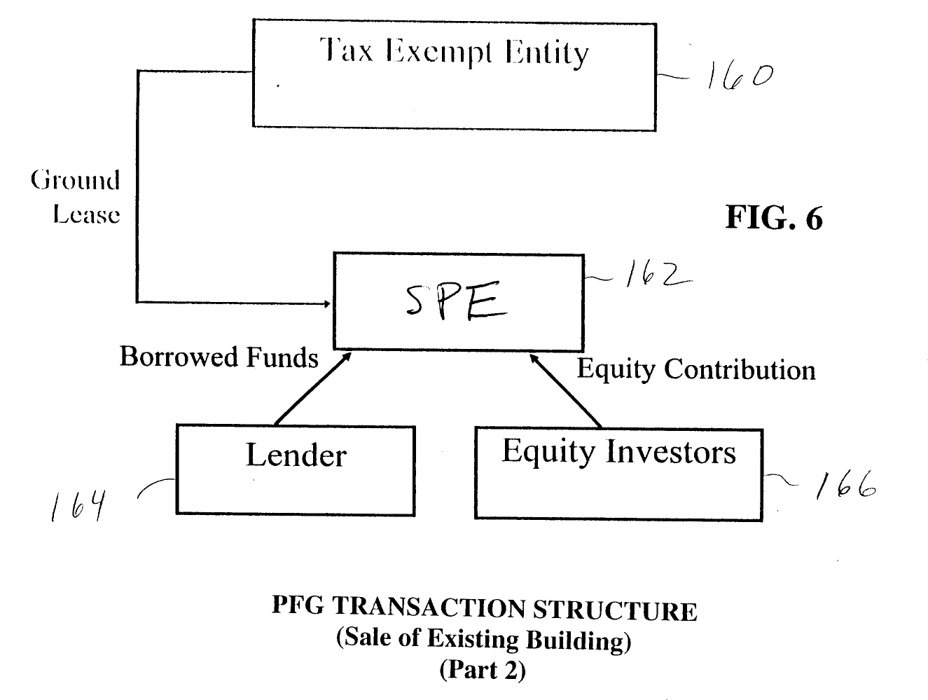

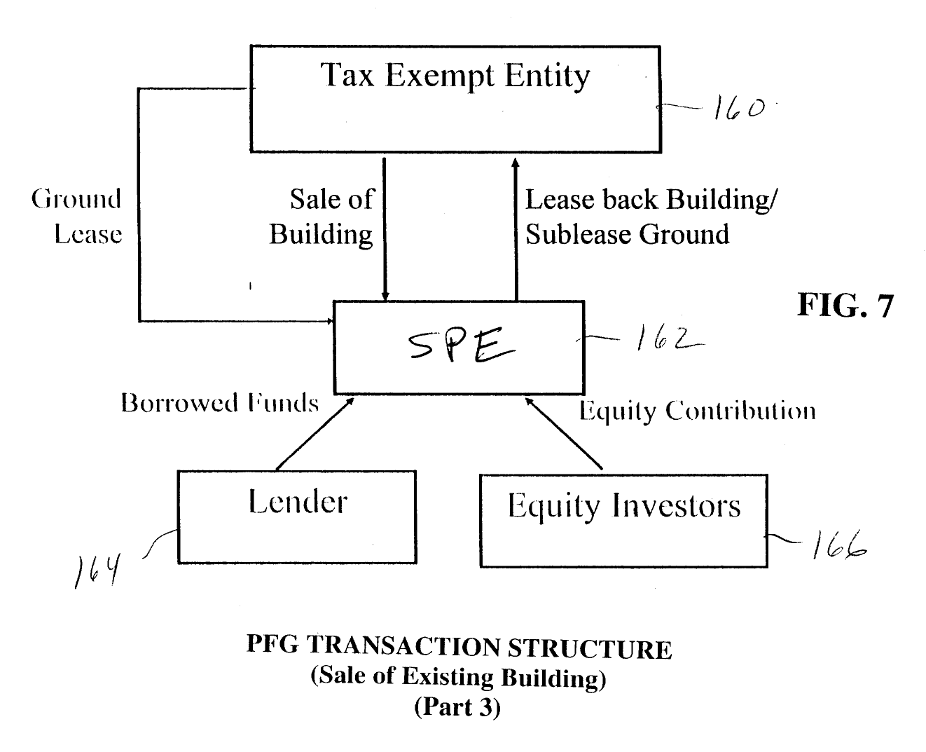

FIGS. 5-7 are structure diagrams illustrating the main parts of a PFG structured transaction involving the sale of an existing building, in accordance with the first embodiment of the invention shown in FIG. 1. As shown in FIG. 5, the tax-exempt entity 160 leases its ground to the SPE 162. As shown in FIG. 6, the SPE 162 then, in this example, borrows funds from a lender 164 and obtains an equity contribution from equity investors 166. As shown in FIG. 7, the SPE 162 then purchases the building and the building is leased back to the tax-exempt entity 160.

FIG. 5A is a structure diagram illustrating an alternative first part of a PFG structured transaction involving the sale of an existing building, wherein a VIE is used as the land holder. In this alternative embodiment, the first step involves the creation of a VIE) 161 and the transfer of ownership of the land from the tax-exempt entity 160 to the VIE 161. The VIE then enters into the ground lease with the SPE 162. This alternative presents another possible method for achieving the desired accounting treatment for the SPE 162. Under FASB interpretation No. 46, “Consolidation of Variable Interest Entities” (an Interpretation of ARB No. 51) (“FIN46”), the SPE is required to account for the land as a capital lease and to consolidate the land owner's assets on its books in accordance with FASB 13 if a VIE is used under certain circumstances. The VIE is used to insure that the only asset to be consolidated is the land. Once the land is treated as a capital lease by the SPE, then the appropriate accounting treatment provides that the land lease will be a capital lease to the SPE, as long as the SPE guarantees a return to the VIE on its land position. This guarantee may be provided in the land lease or otherwise. The SPE applies FASB 13 to the building lease to determine the appropriate accounting treatment. As described herein, the instant invention provides for capital lease treatment for the building through application of the 90% test. The SPE then combines the capital land lease with the capital building lease to achieve consolidated leverage lease treatment. It is noted that FIGS. 6 and 7 still apply to this alternative embodiment, except for the addition of the VIE (not shown in FIGS. 6 and 7). In addition, rather than being a leaseback of the building and a sublease of the ground, it will be a leaseback of both the building and the ground because the tax-exempt entity no longer owns the ground.

FIG. 5B is a structure diagram illustrating another alternative first part of a PFG structured transaction involving the sale of an existing building, wherein a bargain purchase option is available under the ground lease, in accordance with an embodiment of the invention shown in FIG. 1. In this alternative method, the SPE receives an option to purchase the land at the termination of the land lease (typically 65 years). That option will generally be for a minimal amount (e.g., $1). Consequently, the lease of the land to the SPE will be a capital lease. The SPE applies FASB 13 to the building lease to determine the appropriate accounting treatment. As described herein, the instant invention provides for capital lease treatment for the building through application of the 90% test. The SPE then combines the capital land lease with the building lease to achieve consolidated leverage lease treatment. This alternative requires the SPE to account for the land lease as a land purchase over the term of the lease. Consequently, Original Issue Discount (“OID”) treatment will be appropriate. Thus, payments made to the land owner will be considered installment purchase payments (including principle and interest) rather than rent. FIGS. 6 and 7 also apply to this alternative, although they do not show the bargain purchase option.

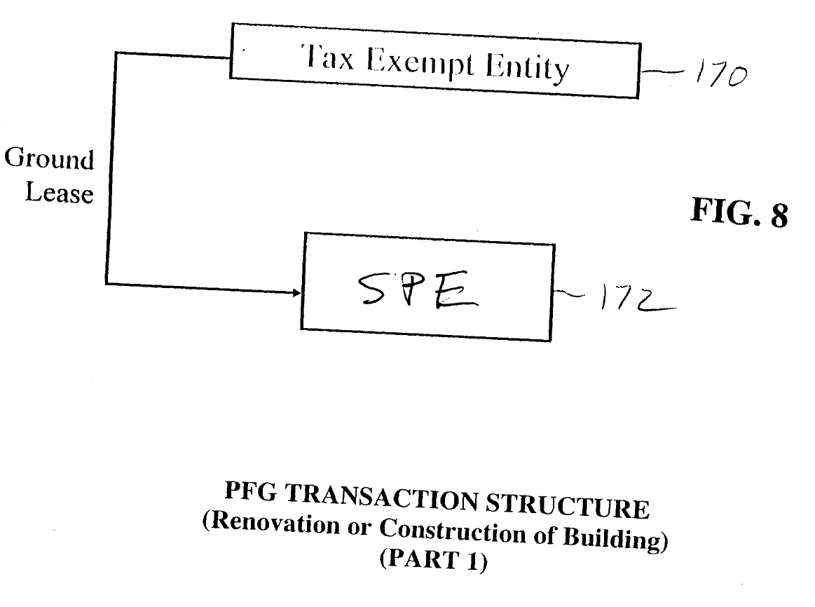

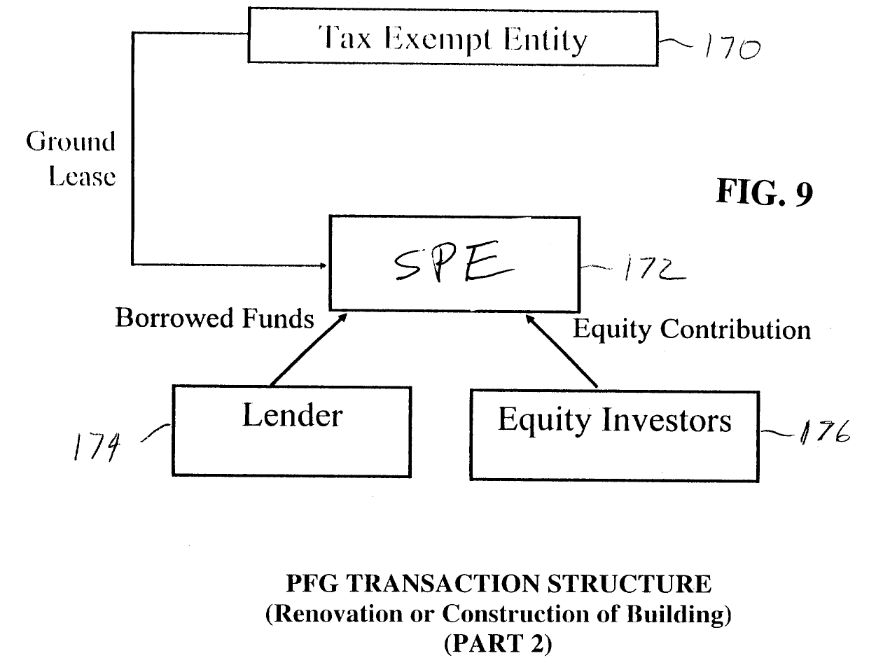

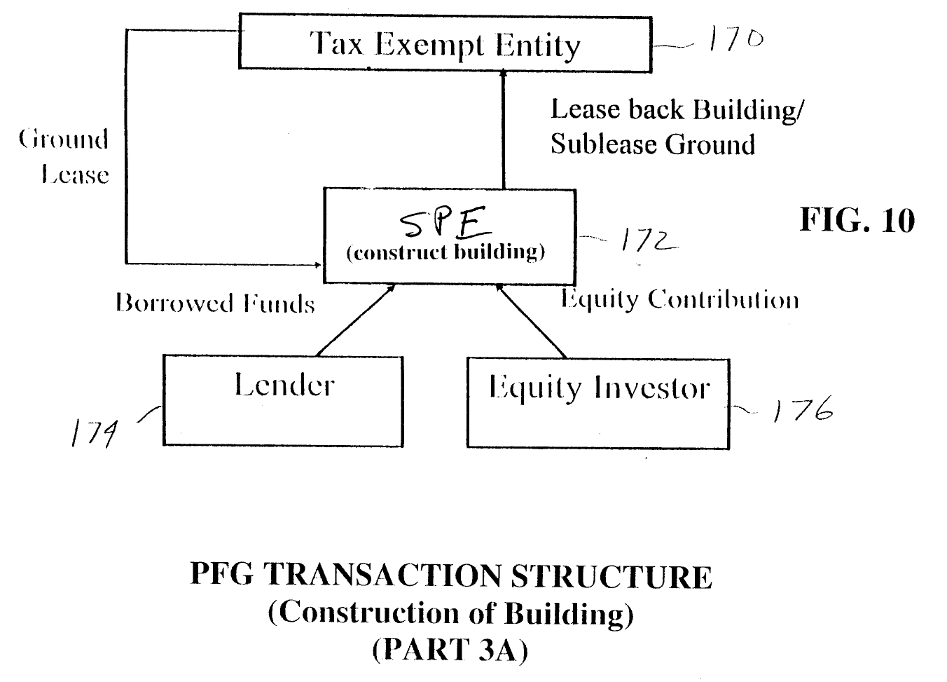

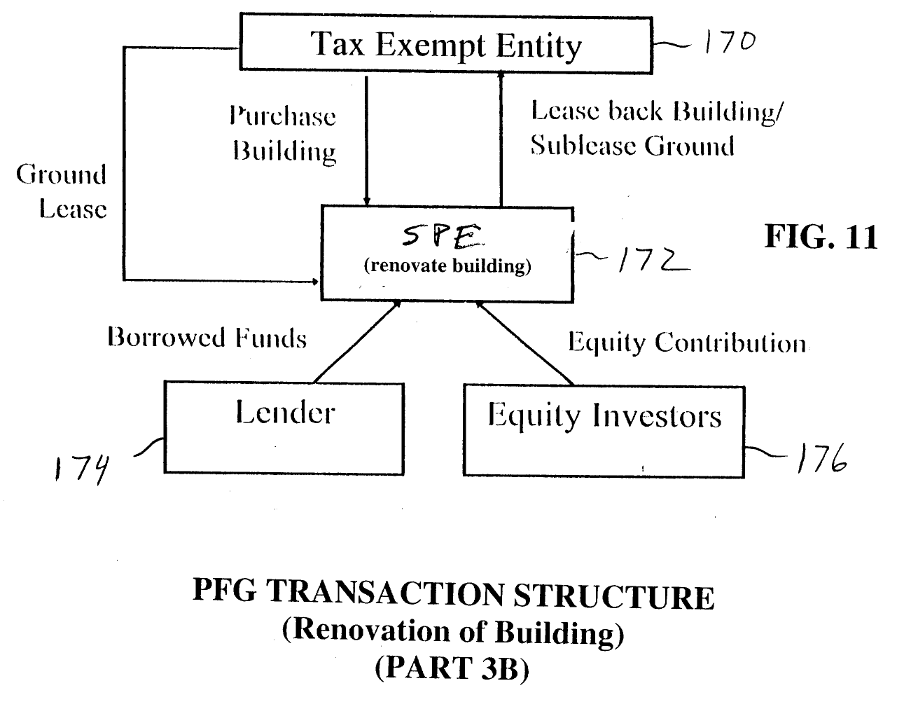

FIGS. 8-11 are structure diagrams illustrating the main parts of a PFG structured transaction involving the renovation or construction of a building, in accordance with the second embodiment of the invention shown in FIG. 2. As shown in FIG. 8, the tax-exempt entity 170 leases the ground to the SPE 172. As shown in FIG. 9, the SPE, in this example, borrows funds from a lender 174 and receives an equity contribution from equity investors 176. The SPE 172 then constructs or renovates and obtains ownership of the building. FIG. 10 illustrates the situation in which the SPE constructs the building. FIG. 11 illustrates the situation in which the SPE renovates an existing building. As shown in FIGS. 10 and 11, the constructed or renovated building is then leased back to the tax-exempt entity 170. It is noted that the alternative methods of using a VIE or a bargain purchase option, as described above in connection with FIGS. 5A and 5B, can be applied in a similar manner to a PFG transaction involving the construction or renovation of a building.

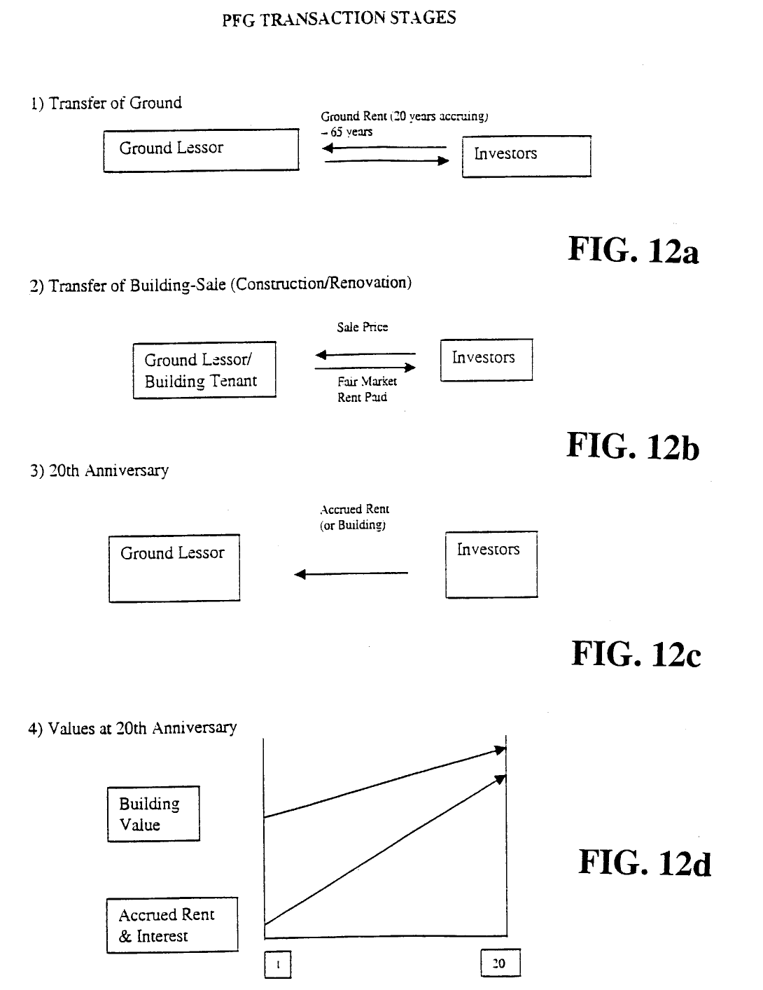

FIGS. 12a-12d illustrate the four stages of an exemplary PFG structured transaction. Specifically, FIG. 12a illustrates the transfer of ground. FIG. 12b illustrates the transfer of the building. FIG. 12c illustrates the accrued rent being paid or the building being given to the ground lessor at the 20^{th} anniversary. FIG. 12d illustrates the value of the building relative to the accrued rent and interest at the 20^{th} anniversary.

As indicated above, in the PFG model, the original owner of the land and building is the lessor of the land but the lessee of the building pursuant to its leaseback. In accordance with the invention, by “netting” the payment stream of the land rent against that of the building rent, the minimum lease payments for the original land owner/building lessee are decreased. This payment stream is then compared with the FMV of the real property, both land and building, to determine whether the 90% test of FASB 13 is met. This netting effect has a significant affect on lease classification under FASB 13. If the present value of the entire rent payment stream were considered and exceeded 90% of the FMV of the real property, then the lessee would have to capitalize the building asset. Thus, the tax-exempt entity would be required to reflect on its balance sheet ownership of the building in addition to the land which is already reflected on its balance sheet. However, under the PFG model, the “net” of the ground rent and the building rent are used in determining the FASB 13 calculation. After netting, the present value does not exceed 90% of the FMV of the property and, as a result, the tax-exempt entity is able to obtain operating lease classification for the building.

The SPE in the above example would have a minimum lease payment equaling the rent received for the leaseback of the building together with sub-leasing of the land. Since the SPE acquired only the building, the lease payment is measured against the value of the building only, and not the land, to determine the SPE's implicit rate in the transaction. Thus, the SPE's present value rent calculation exceeds the 90% test of FASB 13, thereby resulting in capital lease classification for the building. Alternative embodiments are provided in which either a bargain purchase option is utilized or a VIE is established to achieve the desired accounting treatment for the lessor (i.e., capital lease treatment on the land). As noted above, once the land lease is structured so as to achieve capital lease treatment, the leases of the building and the land are consolidated as a capital lease and the SPE is able to utilize leverage lease treatment. The result of the leverage lease treatment is that, under GAAP, the SPE and its equity investors no longer need to declare losses on their financial statements as a result of the transaction, because the gain recognized by the SPE in the twentieth year would be allocated over the initial years of the lease term, thereby offsetting the effects of the deductions taken during this period. The SPE and its equity investors then have both positive income on their financial statements and positive cash flow throughout the term of the building leaseback, as well as significant tax benefits from the transaction. As a result of the impact directly attributable to leverage lease treatment, the transactions no longer require as high a return as that provided from transactions utilizing tax credits under the original model. Thus, the transactions are no longer dependent on the historic rehabilitation tax credit and many more investors can advantageously take part in them.

In the PFG model, the original owner of the real property is generally a tax-indifferent or tax-exempt party. The CPFG model modifies the PFG model so that taxpaying entities, such as corporations, can sell their real property and lease it back at below market rental rates. The CPFG model also provides an innovative real estate investment for non-tax paying entities, such as Pension Funds. The innovative sale/leaseback structure of the CPFG model monetizes 100% of a corporate real estate asset at a low leaseback cost. The CPFG model also enables a pension fund, or other non-tax paying entity, to effectively purchase buildings for only the cost of the land underneath them.

Exemplary corporate sellers that could benefit from the CPFG model include, but are not limited to companies seeking liquidity at long-term fixed rates, monetization of real estate assets, an improvement in earnings, a high ROA, or a restructuring of real estate synthetic leases. Under the CPFG model, corporations can sell real estate at appreciated FMV, realize capital gains versus book and achieve long-term, attractive fixed rate rents. A further benefit is that the leaseback is treated as an operating lease. Additional benefits include: monetizing appreciation trapped in real estate; providing lease renewals at a discount to FMV; and realizing 100% of value in the real estate.

With respect to the non-tax paying entity, such as pension funds, the benefits include: long-term secure yields of, for example, 11%; purchase of a building for the cost of the land alone; annual returns recorded as income; no need to mark to market; building tenant default risk Imitigation; and attractive exit strategies.

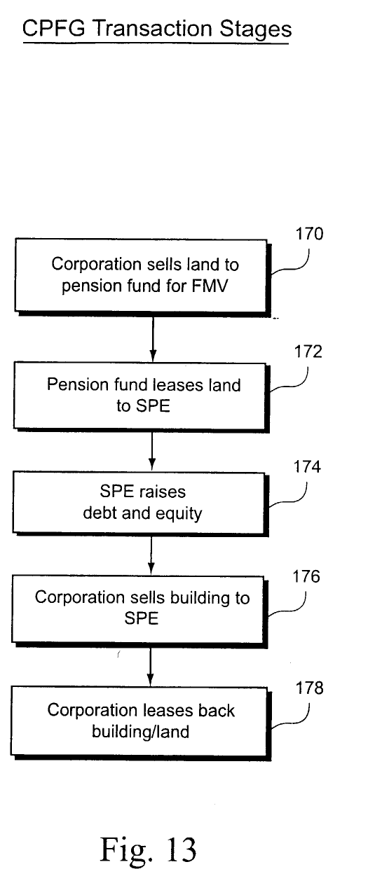

FIG. 13 is a high-level flow chart illustrating the main stages of a CPFG structured transaction. As shown in FIG. 13, the first step (step 170) includes having the corporation sell land to the non-tax paying entity (e.g., pension fund) for FMV. In the next step (step 172), the pension fund leases the land to a SPE. The SPE then raises debt and equity for purchasing the building (step 174). The corporation then sells the building to the SPE (step 176). Finally, the corporation leases back the building and the land (step 178).

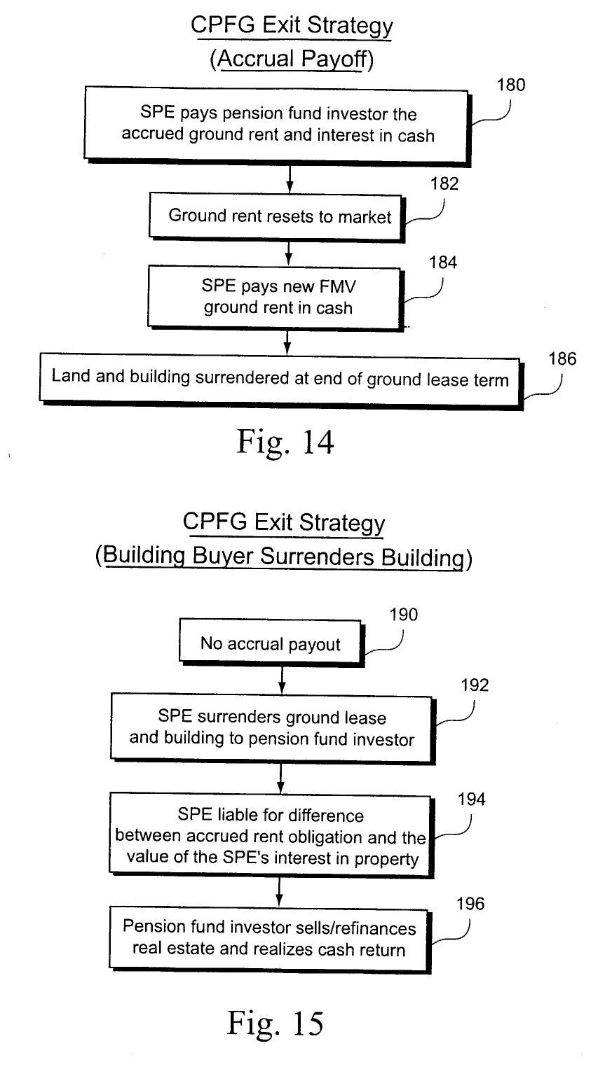

FIG. 14 is a flow chart illustrating a first exit strategy for an exemplary CPFG structured transaction in which the accrual is paid off. As shown in FIG. 14, in this exit strategy, the SPE pays the pension fund investor the accrued ground rent and interest in cash (step 180). The ground rent then resets to market (step 182). The SPE then pays the new FMV ground rent in cash (step 184). Then, the building is surrendered at the end of ground lease term (step 186).

FIG. 15 is a flow chart illustrating a second exit strategy for an exemplary CPFG transaction in which the SPE surrenders the building. As shown in FIG. 15, there is no accrual payout (step 190). Instead, the SPE surrenders the ground lease and building to the pension fund investor (step 192). The SPE is liable for the difference between the accrued rent obligation and the value of the SPE's interest in the property (step 194); the equity investors in the SPE may or may not assume this liability. The pension fund investor may then sell/refinance the real estate asset and realizes a cash return (step 196).

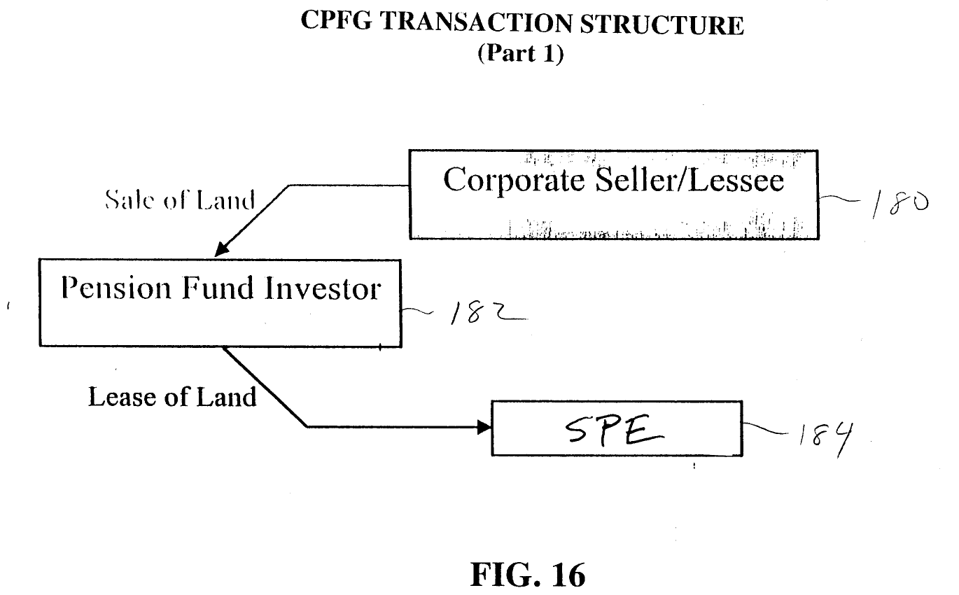

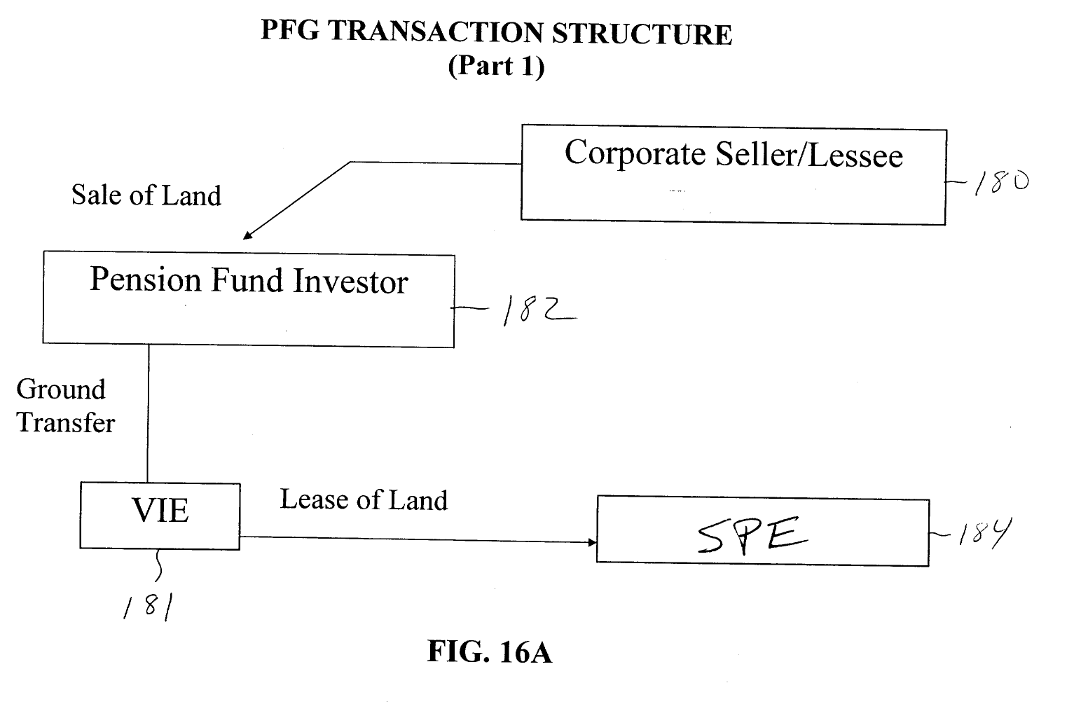

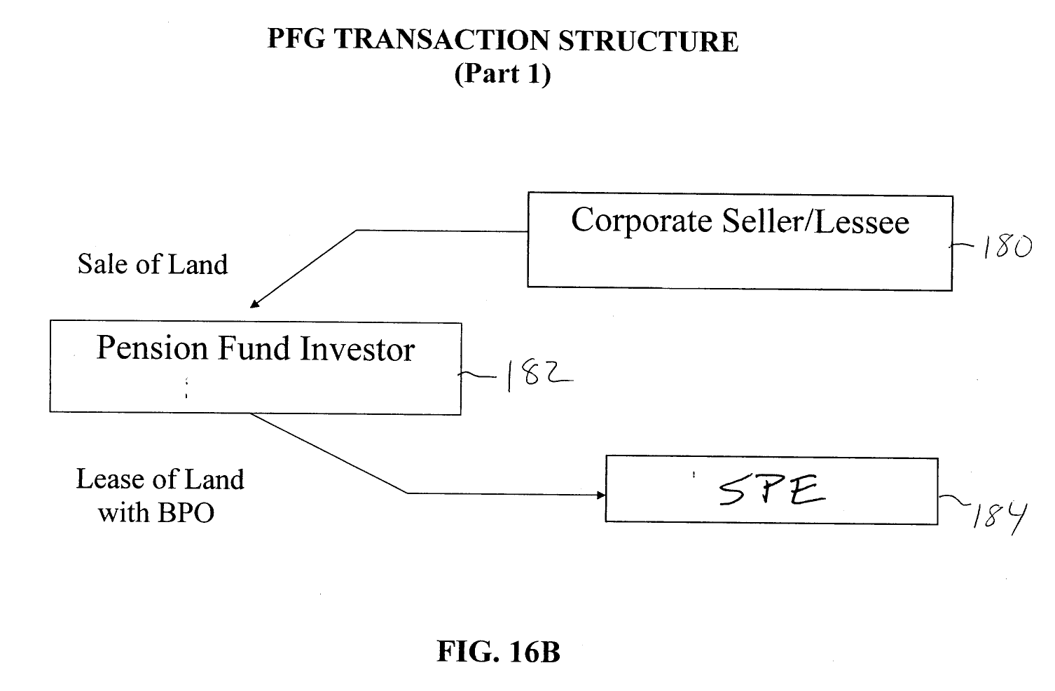

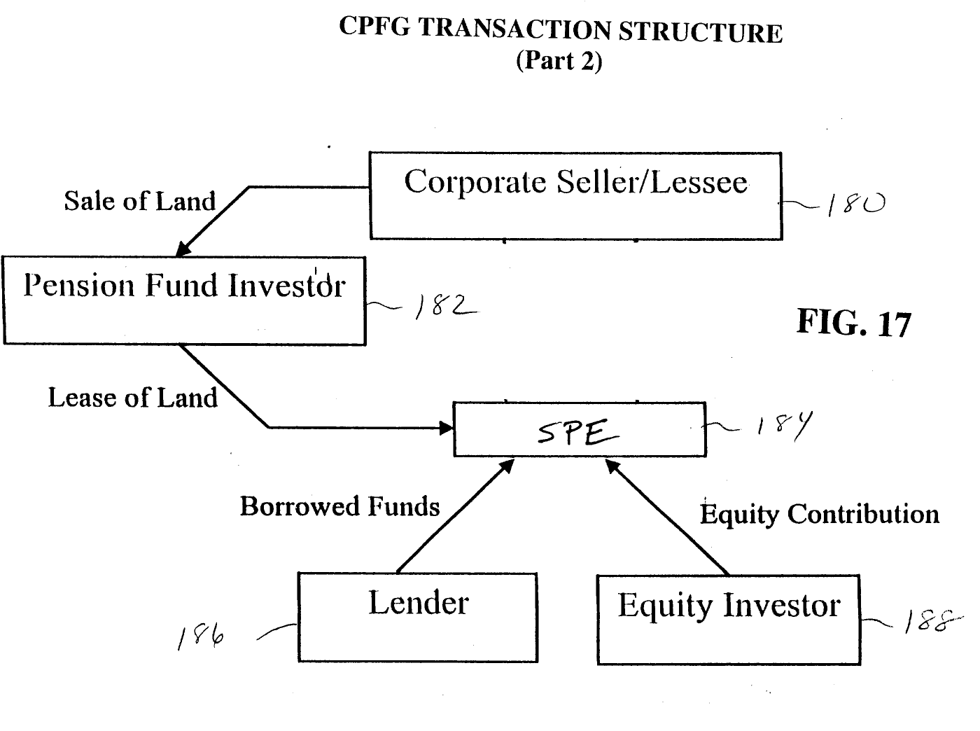

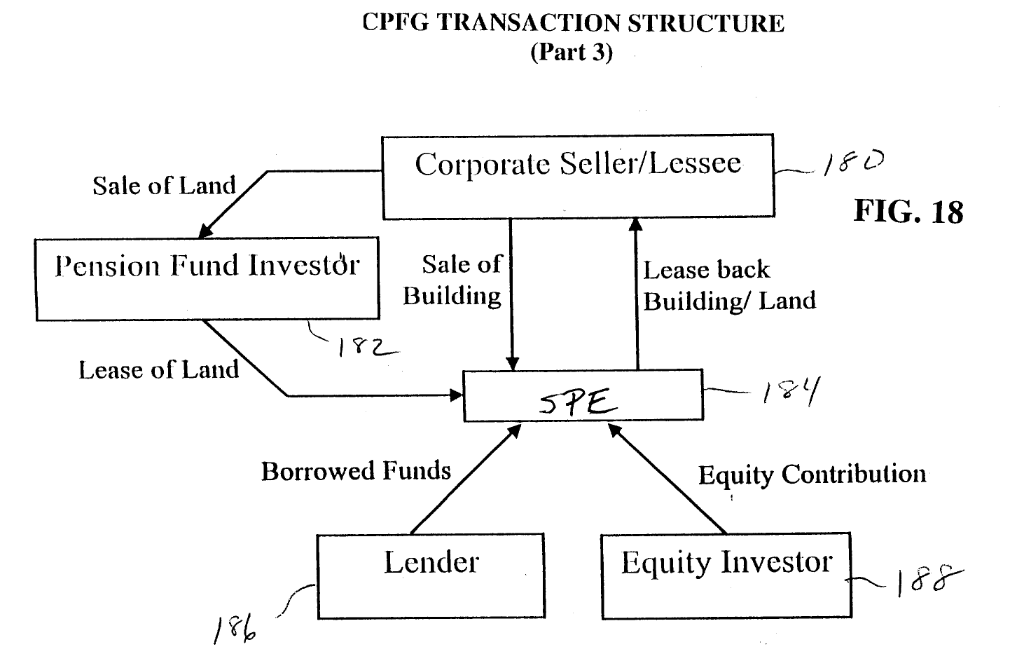

FIGS. 16-18 are structure diagrams illustrating the main parts of a CPFG structured transaction. As shown in FIG. 16, the corporation 180 sells the land to a pension fund (or other non-tax paying entity) 182 for FMV. The pension fund 182 leases the land to the SPE 184. As shown in FIG. 17, the SPE 184, in this example, borrows funds from a lender 186 and gets an equity contribution from an equity investor 188. As shown in FIG. 18, the corporation 180 then sells the building to the SPE 184. Then, the corporation 180 leases back the building and the land from the SPE 184.

FIG. 16A is a structure diagram illustrating an alternative first part of a CPFG structured transaction wherein a VIE 181 is used as the land holder, in accordance with the third embodiment of the invention shown in FIG. 13. In this alternative embodiment, the first step involves the creation of a VIE 181 and the transfer of ownership of the land from the pension fund investor 182 to the VIE 181. The VIE then enters into the ground lease with the SPE 184. This alternative presents another possible method for achieving the desired accounting treatment for the SPE 184. Under FASB interpretation No. 46, “Consolidation of Variable Interest Entities” (an Interpretation of ARB No. 51) (“FIN46”), the SPE is required to account for the land as a capital lease and to consolidate the land owner's assets on its books in accordance with FASB 13 if a VIE is used under certain circumstances. The VIE is used to insure that the only asset to be consolidated is the land. Once the land is treated as a capital lease by the SPE, then the appropriate accounting treatment provides that the land lease will be a capital lease to the SPE, as long as the SPE guarantees a return to the VIE on its land position. The guarantee may be provided in the land lease or otherwise. The SPE applies FASB 13 to the building lease to determine the appropriate accounting treatment. As described herein, the instant invention provides for capital lease treatment for the building through application of the 90% test. The SPE then combines the capital land lease with the capital building lease to achieve consolidated leverage lease treatment. It is noted that FIGS. 17 and 18 still apply to this alternative embodiment, except for the addition of the VIE (not shown in FIGS. 17 and 18).

FIG. 16B is a structure diagram illustrating another alternative first part of a CPFG structured transaction wherein a bargain purchase option is available under the ground lease. In this alternative method, the SPE receives an option to purchase the land at the termination of the land lease (typically 65 years) from the pension fund investor. That option will generally be for a minimal amount (e.g., $1). Consequently, the lease of the land to the SPE will be a capital lease. The SPE applies FASB 13 to the building lease to determine the appropriate accounting treatment. As described herein, the instant invention provides for capital lease treatment for the building through application of the 90% test. The SPE then combines the capital land lease with the building lease to achieve consolidated leverage lease treatment. This alternative requires the SPE to account for the land lease as a land purchase over the term of the lease. Consequently, OID treatment will be appropriate. Thus, payments made to the land owner will be considered installment purchase payments (including principle and interest) rather than rent. The affect of this is to decrease the allowable deductions to the SPE over the term of the operating lease by the amount of the payment allocated to principle. FIGS. 17 and 18 also apply to this alternative, although they do not show the bargain purchase option.

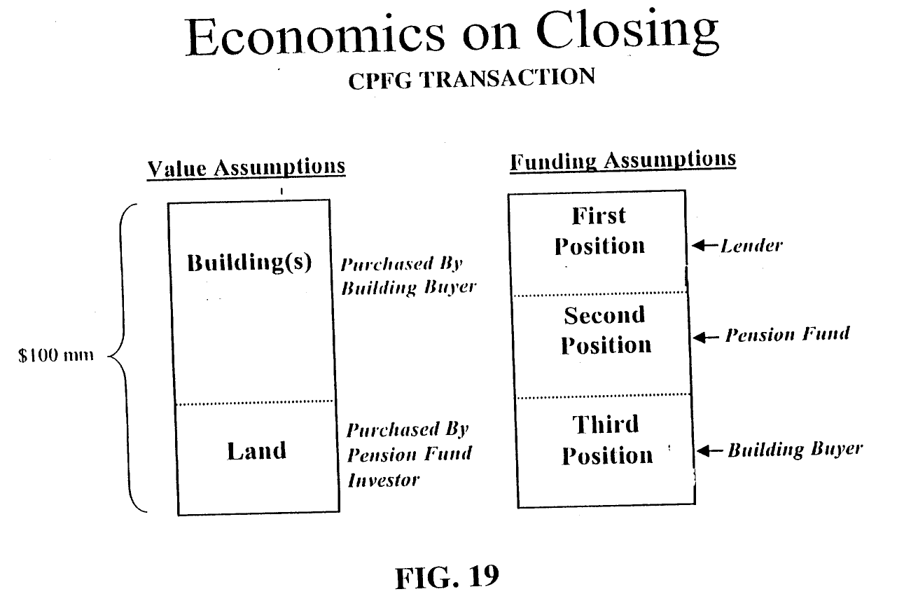

FIG. 19 illustrates the economics on closing for the exemplary CPFG transaction shown in FIGS. 16-18. In certain cases the land owner may partially subordinate its interest in the property to the position of the lender to the SPE.

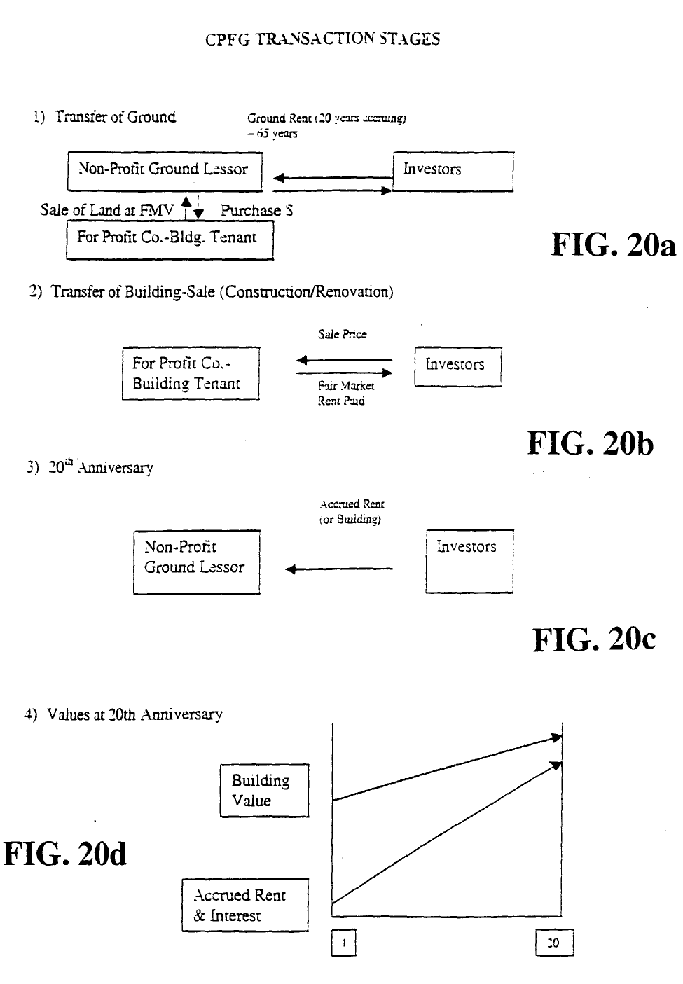

FIGS. 20a-20d illustrate the four stages of an exemplary CPFG structured transaction. Specifically, FIG. 20a illustrates the transfer of ground. FIG. 20b illustrates the transfer of the building. FIG. 20c illustrates the accrued rent or the building being given to the ground lessor at the 20^{th} anniversary. FIG. 20d illustrates the value of the building relative to the accrued rent and interest at the 20^{th} anniversary.

As explained above, in the PFG transaction, the lessee passes the 90% FASB test because of the “netting” that is done using the ground rent. In a CPFG transaction, netting is not available because the lessee sold both the land and the building and thus is not receiving any accrued ground rent on the land. However, the lessee in a CPFG transaction is still able to pass the 90% test, because of the accrual feature of the invention. Specifically, accrual still occurs in a CPFG transaction, and the accrual is being recorded as income by the non-tax paying entity that owns the land. That income to the non-taxing entity (e.g., pension fund) is an expense to the SPE and its equity investors. Since it is an expense that doesn't require a cash outflow, the SPE and its equity investors are able to achieve significant tax advantages. Because of those significant tax advantages, the SPE is able to charge less rent to the lessee in a CPFG transaction then the lessee would be able to receive in a straight sale/leaseback transaction with another type of structure. The lower rent to the lessee in a CPFG transaction allows the lessee to fall below the 90% rate on the FASB 13 4^{th} prong test. Thus, the accrual in a CPFG transaction is still instrumental in achieving the desired accounting treatment for the lessee in a CPFG transaction.

Generally, one difference between a CPFG transaction and a PFG transaction is that, under the PFG transaction, the entity that currently owns the land and the building is a non-tax paying entity. Consequently, the cost of money for this entity is at a tax exempt level, which is generally 150 basis points below the borrowing rate of a taxable entity of the same credit capacity. For example, a municipality like the District of Columbia may be able to borrow money at 5%. However, if this entity was not a municipality, it may have to borrow money at 6½%. In a CPFG transaction, the entity that initially owns the building and the land does not have tax-exempt money available to it. As a result, its cost of money is higher. However, because of the tax benefit that is passed through to the SPE in a CPFG transaction, it is able to charge less rent on the same building. As a result, the cost of money in the CPFG transaction is less than the borrowing rate and enables the 90% test to be passed.

The instant invention is not limited to accrual/deferral of the ground rent in a PFG or CPFG transaction. Other tangible or intangible assets can be used, either alone or in combination with ground rent accrual, to achieve the advantageous results described herein. For example, some properties may not have sufficient land value to support the necessary accrual to provide the benefits described above. In accordance with the instant invention, in these instances and in other instances where, for example, additional cash may be needed for construction/renovation, the accrual/deferral feature of the invention can include deferrals of amounts due with respect to other tangible and/or intangible assets. For example, the land owner may lend money to the SPE and such debt may be repaid on a deferral basis in the same manner, and with the same consequences, as the deferred ground rent in the example described herein. Thus, the instant invention can be used even when the target property does not have sufficient land value for accrual purposes by deferring amounts due with respect to other tangible and/or intangible assets.

Example PFG Transaction

As explained above, a significant advantage of the instant invention is that the accruing asset can be netted against the building rent, thereby providing a lower net rent cost which enables the fourth prong of FASB 13 to be passed. The following provides a detailed description of how this fourth prong of FASB 13 is passed using an exemplary PFG transaction. The following facts, circumstances and assumptions are used in this example PFG transaction:

Enterprise A, a non-tax paying entity, owns land and a commercial building on that land. The building is sold, transferring title to a substantially capitalized SPE (as further described below) for $85 million, which is the fair market value sales price. Enterprise A leases the building back from the SPE and subleases the land. Ownership in the underlying land, which is valued at $15 million, is retained by Enterprise A and is leased to the SPE for a 65 year lease term at fair market rental rates.

The SPE has one or more independent third party equity investors (the “Investor”) that makes an equity investment of $14.6 million representing approximately 17 percent of the fair value of the assets of the SPE at inception. The Investors are one or more substantial corporations (typically Fortune 1000 corporations) that are unrelated to the seller and have 100 percent voting control of the SPE. The equity investment represents an equity interest in legal form, is the only form of equity in the SPE, and is subordinate to all debt interests. There are no dividends, fees, or any other form of payments made to the Investor by the SPE that are in excess of the SPE's previously undistributed GAAP earnings throughout the life of the building lease.

The SPE has obtained non-recourse debt financing, which is provided by a financial institution independent of the SPE, the Investor, and Enterprise A. Enterprise A leases back the building and subleases the underlying land from the SPE for a 20 year term. In another embodiment involving a VIE, Enterprise A leases back both the building and the underlying land. Annual rental payments of $7.8 million are due in arrears. The total rental payments paid by Enterprise A for the leaseback of the building and sublease of the land (leaseback of the land in the VIE embodiment) over the 20 year lease term is $156 million, which is a fair market rental amount. The leaseback of the building contains the following terms and characteristics:

No transfer of ownership to Enterprise A at the end of the lease term;

No obligation and no option to purchase the building by Enterprise A;

No required payment by Enterprise A to the SPE for a decline in the fair value of the building;

No financing will be provided by Enterprise A to the SPE for any portion of the purchase price of the building;

The SPE will not share any portion of the appreciation of the building with Enterprise A;

Enterprise A's rental payment will be at fair market value and will not be contingent on any predetermined or determinable level of future operations of the SPE; and

Enterprise A will not sublease a portion of the building that would result in the present value of the rent for that portion being greater than 10 percent of the fair value of the building at the time of sale.

At the inception of the lease, the rate Enterprise A would incur to borrow the funds necessary to purchase the building over 20 years is 7 percent. Other than the rental payments owed to the SPE and the costs incurred by Enterprise A that relate to executory costs (insurance, maintenance, and taxes paid by the lessor), there are no other fees paid by Enterprise A to the owners of the SPE for structuring this lease transaction or for any other purpose.

Enterprise A leases the underlying land to the SPE with the following terms:

Lease term of 65 years with rent payments of approximately $2.2 million per year for the first 20 years of the underlying land lease, which are determined by an independent appraiser as fair market value.

The lease payments for year 1 through year 20 are structured as follows:

The SPE may make annual payments; or

The SPE may choose to defer the ground rent for the first 20 years. Any rent deferred will incur interest charges at an annual market rate, compounded annually. At the end of 20 years, all deferred rent amounts in addition to interest accrued must be paid in full.

In year 20, independent appraisers will determine the then current fair market value lease payments for the next 20 years for the land. Another fair market valuation will be performed in year 40 to determine the annual lease payments for the remaining 25 years. Land lease payments will be due annually after year 20.

At lease inception, it is reasonable to assume that the SPE will not make the annual land lease payments, but will defer payment and accrue a land lease liability over 20 years at which time the amount of the land lease payments and interest accrued will approximate $107.4 million. In year 20, the SPE will have the following alternatives, and the chosen alternative must be communicated to Enterprise A during the 18th year of the lease term:

1. The SPE pays off the land lease liability by refinancing the building, begins making annual payments under the land lease for the remaining 45 years, and continues to lease the building to either the owner of the land or another tenant; or

2. The SPE sells the building and pays off the land lease liability with the proceeds from the sale. The entity that purchases the building, purchases it subject to the existing underlying land lease in that the new building owner will be obligated to make land lease payments to Enterprise A for the remaining term and may have certain reasonable limitations as to the modifications of the property improvements that can be made on the underlying land (e.g., the color of the bricks used on any improvements to the building must be consistent with those used by the surrounding buildings).

The obligations of the SPE with respect to the land lease may be guaranteed on a full recourse basis by the Investor of the SPE. If using the VIE option, the SPE requires the Investor to provide additional funding to the SPE if the value of the assets in the SPE (i.e., building, land lease position & cash) are insufficient to pay the land lease liability owed to Enterprise A when it comes due.

If using the VIE embodiment, Enterprise A will transfer ownership of its land to the VIE. The obligations of the SPE with respect to the land lease may be guaranteed on a full recourse basis by the Investor of the SPE. The SPE requires the Investor to provide additional funding to the SPE if the value of the assets in the SPE (i.e., building, land lease position & cash) are insufficient to pay the land lease liability owed to Enterprise A when it comes due.

If using the bargain purchase option (“BPO”) embodiment, the BPO is preferably incorporated in the land lease.

Enterprise A (“Lessee”) Accounting for Example PFG Transaction

The PFG transaction described above qualifies for sale-leaseback accounting by Enterprise A. In a transaction that qualifies for sale-leaseback accounting, the seller-lessee records the sale; removes all property and related liabilities from its balance sheet; recognizes gain or loss from the sale in accordance with FASB Statement No. 13, Accounting for Leases (“SFAS 13”) as amended by FASB Statement No. 28, Accounting for Sales with Leasebacks (“SFAS 28”), FASB Statement No. 66, Accounting for Sales of Real Estate (“SFAS 66”) and FASB Statement No. 98, Accounting for Leases: Sale-leaseback Transactions Involving Real Estate, Sales-Type Leases of Real Estate, Definition of the Lease Term, and Initial Direct Costs of Direct Financing Leases (“SFAS 98”); and classifies the leaseback in accordance with SFAS 13, as amended by SFAS 28.

In accordance with SFAS 98, a seller-lessee should use sale-leaseback accounting only if a sale-leaseback transaction involving real estate includes all of the following:

1. A “normal leaseback.”

2. Payment terms and provisions that adequately demonstrate the buyer-lessor's initial and continuing investment in the property acquired. (SFAS 66 defines initial and continuing investment in paragraphs 8-16).

3. Payment terms and provisions that transfer all of the other risks and rewards of ownership as demonstrated by the absence of any continuing involvement by the seller-lessee other than a normal leaseback.

A “normal leaseback” is defined in SFAS 98 as a lessee-lessor relationship that involves the active use of the property by the seller-lessee in consideration for rental payments, including contingent rents that are based on future operations of the seller-lessee, and excludes other continuing involvement provisions that are discussed below. The building leased back by Enterprise A must be used during the lease term in its trade or business, and any subleasing of the leased back building must be “minor.” Otherwise, the sale and lease do not qualify as a sale-leaseback. The description of the transaction indicates a “normal leaseback” in which Enterprise A will not sublease any portion of the building that may result in the present value of the sublease rental payments being greater than 10 percent of the fair value of the building at the date of sale. Accordingly, any subleasing activity will be considered “minor” and will satisfy criterion 1 above.

The transaction would be accounted for as a sale-leaseback transaction in the following manner as prescribed in Example 1 in Appendix A of SFAS 98:

A sale is recorded and the property and any related debt is removed from Enterprise A's balance sheet.

Compute any gain that would be recognized, absent the leaseback, using the guidance in paragraph 39 of SFAS 66. Any loss on sale would be recognized at the date of sale.

Determine whether the leaseback qualifies as a capital lease or an operating lease under the provisions of SFAS 13. As discussed herein, it is assumed that the building leaseback is classified as an operating lease.

Defer the gain and do not commence amortization of the gain until the land lease payments are made, which is assumed to be in year 20.

The leaseback of the building by Enterprise A is classified as either a capital lease or an operating lease in accordance with SFAS 13. If the lease meets one of the following four criteria of paragraph 7 in SFAS 13, the lease should be classified as a capital lease:

1. The lease transfers ownership of the property to the lessee by the end of the lease term.

2. The lease contains a bargain purchase option.

3. The lease term is equal to 75 percent or more of the estimated economic life of the leased property.

4. The present value at the beginning of the lease term of the minimum lease payments, excluding that portion of the payments representing executory costs paid by the lessor, equals or exceeds 90 percent of the excess of the fair value of the leased property.

In this exemplary transaction, the leaseback of the building will not meet any of the four criteria described above for treatment as a capital lease and, therefore, the leaseback will be accounted for as an operating lease. In accordance with paragraph 15 of SFAS 13, Enterprise A should recognize the total rental payments due over the 20 year lease term ($156 million) as an expense on a straight-line basis.

Paragraph 26 of SFAS 13, which provides guidance on the application of the lease classification tests for leases involving land and building, does not specifically address sale-leaseback transactions of real estate where the underlying land is retained by the seller-lessee. However, in applying SFAS 13, it is appropriate for Enterprise A to analyze the leaseback of the building and sublease of the land as separate lease transactions in applying the lease classification tests, rather than as a single unit.

Enterprise A should recognize rental income on the land lease on a straight-line basis, over the lease term in accordance with paragraph 19(b) of SFAS 13. Enterprise A should also recognize interest income, relating to any land lease payments deferred by the SPE, as it accrues based on the market interest rate Enterprise A charges. In addition, the guidance provided in SEC Staff Accounting Bulletin No. 101, Revenue Recognition in Financial Statements (“SAB 101”), should also be considered by SEC reporting entities for this transaction, because the payment terms under the land lease allow the SPE to defer making land lease payments for 20 years.

The future minimum rental payments required as of the date of the latest balance sheet presented, in the aggregate and for each of the five succeeding years, should be disclosed in Enterprise A's financial statements. In addition to the other disclosure requirements of SFAS 13 and SFAS 66, the financial statements of Enterprise A should include a description of the terms of the sale-leaseback transaction and the land lease arrangement, including future commitments and/or obligations. The methodologies used to recognize revenue should be disclosed in Enterprise A's revenue recognition policy. In addition, in accordance with SAB 101 as discussed herein, the extended payment terms on the land lease should be disclosed.

The above detailed, sample PFG transaction is not meant to limit the invention to the specific accounting details or rules described therein (which may change), except as required to meet the main objectives of this aspect of the invention including achieving operating lease treatment for the lessee.

Lessor Accounting

The key to understanding the application of FASB 13, “Accounting for Leases,” is to look at the lease transaction from the perspective of each party. From a lessee's point of view, when the benefits and burdens of ownership of the property leased lie with the lessor, then the lease is an operating lease. In that event the lessee will not be required to record the property and its related liabilities on its balance sheet. By and large, this is the preferred treatment for a lessee and all PFG/CPFG transactions are structured to meet this end. From the lessor's perspective, if the benefits and burdens of ownership are transferred to the lessee, then the lessor will record the lease as either a sales-type lease or a direct financing lease. This is the optimal situation from the lessor's perspective and all PFG/CPFG transactions are preferably structured to accomplish this goal. Obviously, as evidenced above, the parties to every lease have divergent views of the preferred treatment for the lease. Fortunately, FASB 13 allows for both goals to be met.

While a lessee will classify a lease as an operating lease or a capital lease, a lessor will classify a lease as a sales-type, direct financing, leveraged, or operating lease depending upon the facts and circumstances of the particular transaction. A leveraged lease is a form of a direct financing lease. If a lease is classified as a direct financing lease and involves at least three parties, i.e., a lessee, a long-term creditor, and a lessor, with the financing provided by the long-term creditor being non-recourse to the general credit of the lessor, and the lessor's net investment declines and increases before it finally dissolves, then the lease will be termed a leveraged lease.

The concept underlying the accounting for leases by lessors as set forth in FASB 13 is that a lease that transfers to the lessee “substantially all of the benefits and risks incident to the ownership of property should be accounted for as a sale or financing by the lessor.” In other words, if the lessee obtains ownership of the property through the terms of the lease or the lessee effectively pays for the entire property through its lease payments, then the lessor is actually selling or financing the property. Thus, the benefits and burdens of ownership lie with the lessee. The economic effect on the parties in a lease that transfers the benefits and risks of ownership is similar, in many respects, to that of an installment purchase. Consequently, the lessor will account for such a lease as either a sales-type lease or a direct financing lease; all other leases will be accounted for as operating leases.

The question of what constitutes “substantially all of the benefits and risks incident to ownership” is governed by four classification criteria found within FASB 13. The same four classification criteria which were considered by the lessee in determining whether the lease is an operating lease or a capital lease are applied to the lessor to determine whether a lease transfers all of the benefits and burdens of ownership, namely:

a. The lease transfers ownership of the property to the lessee by the end of the lease term.

b. The lease contains an option to purchase the leased property at a bargain price.

c. The lease term is equal to or greater than 75 percent of the estimated economic life of the leased property.

d. The present value of rental and other minimum lease payments equals or exceeds 90 percent of the fair value of the leased property less any investment tax credit retained by the lessor.

In addition, in the case of the lessor, if one (or more) of these criteria is met, the collectibility of the minimum lease payments is reasonably predictable and there are no important uncertainties surrounding the amount of unreimbursable costs yet to be incurred by the lessor under the lease, then the lease is classified as a sales-type lease, a direct financing lease, or a leveraged lease to the lessor.

Obviously, the first three criteria require both parties to treat the lease similarly. For example, if a lease transfers ownership of the leased property at the end of the lease term, then this criterion's result is the same for both parties. Thus, the first three criteria allow one party to the lease to receive the accounting treatment it desires but not the other party.

Because of the way in which the fourth classification criterion is calculated, divergent treatment and lease accounting by the parties is possible thereby providing the optimal result for each. In certain circumstances, this criterion may allow the lessee to treat a lease as an operating lease while the lessor treats the same lease as a sales-type lease, a direct financing lease, or a leveraged lease. In other words, from the point of view of the lessee the risks and benefits of ownership lie with the lessor but from the point of view of the lessor the same risks and benefits lie with the lessee. This result permits the goals of both parties to the lease to be achieved. Although this appears intuitively impossible, the fourth criterion permits such treatment as discussed below.

The fourth criterion, also known as the “90% Recovery Test,” compares the present value of the minimum required payments under the lease with the property's value to determine whether the risks and benefits of ownership have been transferred. Specifically, a lease is not an operating lease to the lessor if the “present value at the beginning of the lease term of the minimum lease payments . . . equals or exceeds 90 percent of the . . . fair value of the leased property to the lessor at the inception of the lease.” The present value of the minimum required payments is likely to vary depending on whether it is viewed on behalf of the lessee or the lessor. The lessor computes the present value of the minimum lease payments using the interest rate implicit in the lease while the lessee generally uses its cost of funds in determining the present value of the minimum lease payments. Therefore, the disparate treatment is possible if the lessee's cost of funds is greater than the interest rate implicit in the lease as calculated by the lessor.

The lessor's implicit interest rate is defined as “the discount rate that, when applied to (a) the minimum lease payments . . . and (b) the unguaranteed residual value accruing to the benefit of the lessor causes the aggregate present value at the beginning of the lease term to be equal to the fair value of the leased property to the lessor at the inception of the lease . . . .” FASB L10.412. Thus, the implicit rate is a function of the minimum lease payments, the fair value of the leased property to the lessor at the inception of the lease, and the unguaranteed residual value of the leased property that benefits the lessor.

While the “minimum lease payments” are generally clearly established by the underlying lease, and the fair value of the property to the lessor at the inception of the lease is apparent in the transaction, the unguaranteed residual value of a leased property is a subjective valuation on the part of the lessor. Obviously, the valuation of the residual is dependent upon the facts and circumstances of the particular transaction but, most importantly, it is the estimated fair value of the leased property at the end of the lease term “accruing to the benefit of the lessor.” Thus, if the lessor is not entitled to any amount on disposition of the property, then no unguaranteed residual value would accrue to its benefit. FASB L10.412 fn 403. If the fourth criterion is met from the lessor's perspective, then the lease passes the benefits and burdens of ownership to the lessee and the lessor will classify the lease as either a sales-type lease or a direct financing lease. Leases that involve lessors that are primarily involved in financing operations, as is the case in all PFG/CPFG transactions, will be direct financing leases.

Once it is determined that a lease is a direct financing lease, the lease may be considered a leveraged lease provided it has all of the following characteristics:

a. It involves at least three parties: a lessee, a long-term creditor, and a lessor.

b. The financing provided by the long-term creditor is substantial to the transaction and is nonrecourse to the lessor.

c. The lessor's net investment declines during the early years and increases during the later years of the lease term.

d. Any investment tax credit retained by the lessor is accounted for as one of the cash flow components of the lease.

Because of the favorable GAAP accounting treatment associated with a leveraged lease, a direct financing lease is often structured to meet the above characteristics.

As a leveraged lease, the lessor would record the investment net of the nonrecourse debt. Thus, the loan associated with the leased property is offset against the property's fair value and only the difference, i.e., the lessor's equity in the transaction, would be shown on the lessor's balance sheet. Additionally, from an income statement purpose, the total net income over the lease term is calculated by deducting the original investment from total cash receipts. By using projected cash receipts and disbursements, the rate of return on the net investment in the years in which the investment is positive is determined and applied to the net investment to determine the periodic income to be recognized. Income would be recognized only in periods in which the net investment net of related deferred taxes is positive. Thus, the lessor would be able to report positive earnings on its GAAP financial statements at the same time its tax returns indicate yearly losses. At the end of the lease term, the earnings reported for both tax and GAAP purposes will be the same; it is only the timing of those earnings that differs. L10 Summary, p.7.

In accordance with the invention, the PFG/CPFG transactions are preferably structured to provide operating treatment to the lessees and leverage lease treatment for the lessors. In one preferred embodiment, the lessor achieves leverage lease treatment through the application of the fourth criteria, the 90% test. In other embodiments, the lessor achieves capital lease treatment on the land using a bargain purchase option or VIE. Since all PFG/CPFG transactions are, by their very nature, financings, the leases will be direct financing leases if operating lease treatment is avoided for the lessor. The fourth criterion should be applied from the lessor's perspective as follows.

The fourth criterion in a direct financing lease requires that, from the perspective of the lessor, the present value of the minimum lease payments equal or exceed 90% of the value of the leased property. It is necessary to determine the implicit interest rate in a lease to calculate the present value of the lease payments. Of the three variables included in the determination of the interest rate implicit in the lease, two of them are clearly established in a PFG/CPFG transaction, namely the “minimum lease payments” and the fair value of the property to the lessor at the inception of the lease. Because of the unique nature of the ground rent accrual in a PFG/CPFG transaction, the third component, the unguaranteed residual value of a leased property, is the difference between the projected value of the building and the offsetting ground accrual liability. As expressly noted in the definition of the interest rate implicit in the lease, it may include “factors which a lessor might recognize in determining his rate of return.” FASB L10.412. In a PFG/CPFG transaction, the ground accrual is a key element in the determination of the lessor's rate of return in its investment and should be considered in the valuation of the residual value.

Because the lessor's investment in the building is substantially diminished by its obligation to pay the associated land lease accrual, the unguaranteed residual value must be reduced by the accrual. In all PFG/CPFG transactions an appraisal is done at the inception of the transaction which is the most reasoned assessment of the future valuation of the building based upon the facts and circumstances available at that time. The ground lease accrual is also firmly established by the lease. Thus, the unguaranteed residual value of the property accruing to the benefit of the lessor at the end of the lease should be the difference between the ground accrual and the projected valuation of the building. Since the ground accrual is set to be approximately eighty-five percent of the projected future value of the building, the unguaranteed residual value is fifteen percent of the projected future value of the building.

Under the most conservative of assumptions in a PFG/CPFG transaction, namely the “Walk-away Scenario,” it is assumed that the building appreciates at only eighty-five percent of the projected appreciation rate. Thus, the “value” accruing to the benefit of the lessor in such a scenario would be nothing since the lessor will simply exchange the building for the ground accrual liability. If the lessor is not entitled to any amount on disposition of the property, then no unguaranteed residual value would accrue to its benefit. FASB L10.412 fn 403. If, however, the asset appreciates to a value greater than eighty-five percent of the original appraisal's projected ending value, then the lessor will benefit by the difference of this amount and the ground accrual liability. Therefore, the unguaranteed residual value in any PFG/CPFG transaction should be set between nothing and fifteen percent of the future projected value.

From the perspective of the lessor, the fourth criterion is easily passed in all PFG/CPFG transactions when the unguaranteed residual value is set at fifteen percent of the future projected value. In other words, from the perspective of the lessor the minimum lease payments cover 90% or more of the fair value of the leased property. Since these transactions are “financings,” they are also classified as direct financing leases. Furthermore, because the transactions are structured to meet the leveraged lease criteria, the transactions qualify for leveraged lease treatment.

The rationale expressed above support leveraged lease treatment for all lessors in PFG/CPFG transactions. Because of the impact of the ground accrual to the lessor's rate of return on the transaction, the ground accrual must be considered in determining the residual value of the transaction accruing to the benefit of the lessor. By netting the accrual against the projected future appraised value of the building, the lessor's residual value will be approximately fifteen percent of the future value of the building. Using this amount as the residual value in calculating the interest rate implicit in the lease, from the lessor's perspective the 90% Recovery Test is met. Thus, the lessor in all PFG/CPFG transactions should be accorded leveraged lease treatment.

Computer Modeling Tool:

The above-referenced provisional application includes, as Attachments 3 and 5, respectively, printouts of computer spreadsheets used in connection with the PFG and CPFG models. These spreadsheets are used to analyze and qualify possible properties for use in accordance with the instant invention. The spreadsheets define models that are used to simplify the optimization of the overall transactions for the parties involved. Copies of the main spreadsheet and the supporting spreadsheets are provided for both the PFG and CPFG models in the provisional application. For example, spreadsheets are provided which show three ways to calculate the IRR for two different possible scenarios for each model. The first scenario assumes that the investor will walk away from the property after the initial deferral period (e.g., 20 years). The second scenario assumes that the investor will keep the land and refinance the property. It is noted that some of the calculations for the IRR have been truncated due to the number of pages required to print the entire spreadsheet. However, the methodology used for these calculations can be seen from the pages provided and can easily be understood by one skilled in the art. All of the spreadsheets from the provisional application are incorporated herein by reference. However, the spreadsheets only provide a tool for simplifying the transaction structure and determining if the conditions described above are satisfied. This work can be done using any suitable spreadsheet or other computer application using known techniques and applying the teachings of the instant invention.

In order to provide a better understanding of the exemplary computer modeling tool used by the instant inventors, a further discussion of its purpose and operation is provided below.

The computer model is designed to qualify transactions and perform a balancing for all parties to the transaction. For example, the model attempts to achieve the advantageous accounting treatment described above. Specifically, the computer model runs numbers to determine if the transaction will pass the 4^{th} prong of FASB 13 for the lessee, thereby enabling the lessee to treat the lease as an operating lease. At the same time, the computer model runs numbers to determine if the transaction will pass the 4^{th} prong of FASB 13 for the lessor, thereby achieving leverage lease treatment for the lessor. Thus, the model assists in structuring a specific transaction so as to have the FASB 13, 4^{th} prong be less than 90% for the lessee and greater than 90% for the lessor. The model takes into account the time value of money and the present value of the asset involved, and determines, for example, what amount of rent will need to be charged to the lessee in order to pass FASB 13 and still achieve a desired return for the lessor. For example, if a target IRR for the transaction is 9½%, which may be the minimum required return for any investor in this transaction, that will require that the lessee pays a certain amount of cash in order to achieve that return. The computer model assists in structuring the transaction so as to make sure that that payment of cash does not violate the 90% test for the lessee.

As indicated above, the computer model helps balance the needs of the different parties to the transaction. From the lessee's perspective, operating lease treatment and the lowest possible rent is desired. Of course, the lower the rent, the less return that will be realized by the lessor. The computer model helps determine, using known mathematical and accounting techniques, the minimum acceptable level of return needed by the lessor, which then indicates the necessary rent to the lessee. In this regard, the computer model can be used to determine what the rent should be, taking into account the equities tax position. That rent can then be compared to what would be achievable for the lessee if they went out to the marketplace and obtained a straight loan. Generally speaking, it has been found that the lessee saves between 30-50 basis points when using the transaction structures of the instant invention. In other words, by bringing in equity at low cash cost, that low cash cost equity can be mixed with achievable debt to achieve an overall cost of capital to the lessee that is, for example, 20 to 50 basis points less than what the lessee could achieve in the marketplace. In addition, if the lessee went to the marketplace and borrowed money at the market rates, it would treat the borrowing as a capital lease which would be on its books both as debt and equity. As explained above, the PFG and CPFG transaction structure of the invention enables operating lease treatment, thereby avoiding treatment on the balance sheet.

In connection with a PFG transaction, the interests of two parties must be balanced—the lessee and the lessor. The lessee is the original owner of both the land and the building. The lessor purchases the building and leases the land and subsequently leases both properties, the building and the land back to the lessee. Thus, the computer model assists in balancing the interests of the lessee and the lessor in a PFG transaction.

In a CPFG transaction, the selling party is generally a tax-paying entity. The tax-paying entity sells both its land and its building and treats this transaction like a straight lease back of its property. In a CPFG transaction, the land is being purchased by a non-tax paying entity, such as a pension fund. The pension fund can absorb income in the form of the accrued amounts. The building is purchased by equity investors. Thus, in a CPFG transaction, the computer model helps to balance the interests of three parties—the tax-paying entity, the non-tax paying entity and the equity investors. This balancing involves trying to achieve a suitable IRR for the equity investor, trying to achieve the lowest possible rent for the tax-paying entity and trying to achieve a suitable IRR for the non-taxpaying entity.

The non-taxpaying entity IRR is achieved in a form that is similar to a zero coupon bond. In other words, the non-taxpaying entity purchases the land today for a certain amount of money. The non-taxpaying entity does not receive any cash during the deferral term of the lease (e.g., 20 years). At the end of the deferral term, the non-taxpaying entity receives the amount of the accrual on the ground rent, for example, and that accrual will result in a return to the non-taxpaying entity (e.g., 10%). Thus, the computer model balances a desired return for the land owner, a desired return for the equity investor, and a desired rent payment (or cap rate) from the seller of the land and building, while also assuring that the desired lease treatment is achieved for the parties under FASB 13.

The above-described structuring and balancing can be done using any suitable method and does not require use of any specific tool. The analysis, structuring and balancing for the transaction is done using known mathematical and accounting techniques, as one skilled in the art will understand from the description of the invention herein. Thus, further details of the computer model are not provided herein in order to avoid obscuring the invention with unnecessary details of an exemplary computer tool. However, detailed spreadsheets from the exemplary computer tool are provided in the above-referenced provisional application, incorporated herein by reference.

PFG and CPFG General Transaction Steps

The following description provides a basic overview of the main steps taken to assemble the parties and necessary elements for a PFG or CPFG transaction, in accordance with a preferred embodiment of the invention.

The first step is for a transaction service provider to market a proposed sale-leaseback transaction to potential clients interested in restructuring their real estate holdings (tax-indifferent parties in the case of PFG transactions; taxpaying entities in the case of CPFG transactions). This involves: explaining separation of ownership of land and building under the PFG/CPFG model; explaining the ground rent accrual feature under the PFG/CPFG model; explaining the rights and obligations of all parties to the transaction throughout the life of the transaction; explaining the exit strategies; explaining the benefits of following the model; and explaining the accounting and tax treatments under the model.

If a potential client is interested in the transaction, the next step involves producing a pro forma financial structure under the model for the client's particular real estate project. If a potential client wishes to proceed, the next step involves refining the structure based on additional information from the potential client concerning its current real estate values and goals from a possible transaction.

The next step involves determining whether there is interest by the potential client, potential investors, potential lenders, and, if CPFG transactions, potential tax-indifferent parties interested in acquiring land for investment. If sufficient interest is shown by the above parties, the next step is to prepare a Plan of Finance for the contemplated transaction to present to the potential client. If the client accepts the Plan of Finance, the client is committed to proceed and the transaction service provider then has, for example, between 30 to 90 days to secure investors, lenders, and, in CPFG transactions, land acquisition parties to participate in the transaction.

Finally, steps are then taken to close the transaction. This includes preparing the following documents to implement the transaction: a sales agreement for, and deed to, the land in the PFG VIE model or the CPFG model; a ground lease; a space leaseback; limited partnership or limited liability company agreement to organize the SPE; to the extent requested, loan documents for a development loan to help finance the transaction; a private placement memorandum if necessary to select the potential investors and investor subscription documents; and standard real estate closing documents. Tax and/or accounting opinions are then obtained. An appraisal of the property is obtained. Title to the property is searched and cleared, as needed. A property survey is obtained. Any necessary environmental remediation is done or arranged for. Any necessary steps are taken to obtain applicable tax credits. In construction or renovation transactions, a guaranteed maximum price (gmp) construction contract and architect's agreement is negotiated. The necessary insurance coverage is arranged. Other additional actions are taken as needed or desired.

As explained in detail above, the instant invention provides significant advantages as compared to prior real estate financing methods. For example, from the lessee's perspective, the transactions are structured so that they achieve operating lease treatment, thereby avoiding adverse impact to the lessee's balance sheet. At the same time, from the lessor's perspective, the transactions are structured to achieve leverage lease accounting treatment, thereby removing the real estate and its associated liabilities from the lessor's balance sheet and enhancing its credit ratings. This advantageous accounting treatment is achieved through accrual of the ground rent either alone or in combination with other tangible or intangible assets. In accordance with the invention, the accrual enables leverage lease treatment to be achieved for the lessor in both PFG and CPFG transactions.

In a PFG transaction, the netting of the ground rent versus the building rent enables operating lease treatment by the lessee under FASB 13. In a CPFG transaction, the accrual is also instrumental in achieving operating lease treatment for the lessee by allowing lower rent payments. Thus, the invention provides novel methods of using an accrual to achieve the desired accounting treatment for all parties to a real estate transaction.

While the preferred embodiments of the instant invention have been illustrated and described herein, various changes and modifications may be made without deviating from the true scope and spirit of the invention. Thus, the description herein is meant to be exemplary only and is not intended to limit the scope of the appended claims beyond the express scope thereof.

What is claimed is:

1. A method of funding real estate, wherein the real estate is owned by a tax-indifferent party and includes land with an existing building thereon, said method comprising:
leasing the land to an investor entity;
selling the building to the investor entity;
leasing back the building to the tax-indifferent party;
netting the ground rent due under the land lease against the building rent due under the building leaseback to achieve operating lease classification for the tax-indifferent party; and
setting the building rent at a level that enables leverage lease classification for the investor entity.

2. The method defined in claim 1, further including using a land lease having a defined land lease term and a defined deferral period of the lease term in which the land rent can be deferred and accrued with interest.

3. The method defined in claim 2, wherein the land lease term is between 50 and 65 years.

4. The method defined in claim 2, wherein the deferral period is between 15 and 25 years.

5. The method as defined in claim 2, wherein the land lease term is 65 years and the deferral period is 20 years.

6. The method as defined in claim 2, wherein at the end of the deferral period, the investor entity surrenders a remaining term of the land lease and the building to the tax-indifferent party, and is liable to the tax-indifferent party for a difference between an accrued rent obligation and the value of the investor entity's interest in the property.

7. The method as defined in claim 2, wherein at the end of the deferral period, the investor entity pays the tax-indifferent party the accrued land rent and interest, the land rents resets to market, the investor entity pays land rent currently, the tax-indifferent party has the option to rent all of some of the building, and the building is surrendered at the end of the land lease term or upon earlier default by the investor entity.

8. The method as defined in claim 1, further including transferring another tangible and/or intangible asset from the tax-indifferent party to the investor entity, and netting the combined amount due for this other asset and for the land lease against the amount due under the building lease in order to achieve the operating lease classification for the tax-indifferent party.

9. A method of funding real estate, wherein the real estate is owned by a tax-indifferent party and includes land with a building desired to be constructed or renovated, said method comprising:
leasing the land to an investor entity;
constructing or renovating the building by the investor entity;
leasing back the building to the tax-indifferent party;
netting the ground rent due under the land lease against the building rent due under the building leaseback to achieve operating lease classification for the tax-indifferent party; and
setting the building rent at a level that enables leverage lease classification for the investor entity.

10. The method defined in claim 9, further including using a land lease having a defined land lease term and a defined deferral period of the lease term in which the land rent can be deferred and accrued with interest.

11. The method defined in claim 10, wherein the land lease term is between 50 and 65 years.

12. The method defined in claim 10, wherein the deferral period is between 15 and 25 years.

13. The method as defined in claim 10, wherein the land lease term is 65 years and the deferral period is 20 years.

14. The method as defined in claim 10, wherein at the end of the deferral period, the investor entity surrenders a remaining term of the land lease and the building to the tax-indifferent party, and is liable to the tax-indifferent party for a difference between an accrued rent obligation and the value of the building.

15. The method as defined in claim 10, wherein at the end of the deferral period, the investor entity pays the tax-indifferent party the accrued land rent and interest, the land rents resets to market, the investor entity pays land rent currently, the tax-indifferent party has the option to rent all of some of the building, and the building is surrendered at the end of the land lease term or upon earlier default by the investor entity.

16. The method as defined in claim 9, further including transferring another tangible and/or intangible asset from the tax-indifferent party to the investor entity, and netting the combined amount due for this other asset and for the land lease against the amount due under the building lease in order to achieve the operating lease classification for the tax-indifferent party.

17. A method of funding real estate, wherein the real estate is own by a tax-paying party and includes land with a building thereon, the method comprising:
selling the land to a tax-indifferent party;
leasing the land from the tax-indifferent party to an investor entity;
selling the building to the investor entity;
leasing the building and the land from the investor entity to the taxpaying party; and
setting the land rent due under the land lease and setting the building rent due under the building lease at levels that enable operating lease classification for the tax-paying party and leverage lease treatment for the investor entity.

18. The method defined in claim 17, further including using a land lease having a defined land lease term and a defined deferral period of the lease term in which the land rent can be deferred with interest.

19. The method defined in claim 18, wherein the land lease term is between 50 and 65 years.

20. The method defined in claim 18, wherein the deferral period is between 15 and 25 years.

21. The method as defined in claim 18, wherein the land lease term is 65 years and the deferral period is 20 years.

22. The method as defined in claim 18, wherein at the end of the deferral period the investor entity pays the tax-indifferent party accrued land rent and interest, the land rent resets to market, the investor entity pays new ground rent currently, and the building is surrendered to the tax-indifferent party at the end of the land lease term.

23. The method as defined in claim 18, wherein at the end of the deferral period, the investor entity surrenders the land lease and the building to the tax-indifferent party and the tax-indifferent party sells or refinances the real estate.

24. The method of claim 17, wherein the tax-paying party is a corporation and the tax-indifferent party is a pension fund.
